(19) United States
(12) Patent Application Publication
(10) Pub. No.: US 2018/0101894 A1
(43) Pub. Date: Apr. 12, 2018

(54) Providing On-Demand User-Based Services Through Use Of Portable Computing Devices

(71) Applicants: Jon Edward Markoff, Hempstead, NY (US); John Imadomwanyi, San Francisco, CA (US)

(72) Inventors: Jon Edward Markoff, Hempstead, NY (US); John Imadomwanyi, San Francisco, CA (US)

(21) Appl. No.: 15/291,067

(22) Filed: Oct. 12, 2016

(51) Int. Cl. G06Q 30/06; G06Q 10/02

(52) U.S. Cl. CPC G06Q 30/0641; G06Q 30/0639; G06Q 10/02

(57) ABSTRACT

The invention is to a system and method for providing on-demand user-based services to a user's person (user-based services) through the use of portable computing devices.

### CROSS-REFERENCE TO RELATED APPLICATIONS

N/A

### TECHNICAL FIELD

Embodiments described herein pertain generally to a system and method for providing on-demand user-based services to a user's person (user-based services) through the use of portable computing devices.

### BACKGROUND

Current user-based services, such as grooming (via barber's), make-up artistry, hair styling, massaging, facials, peels, and other services delivered to a user's person typically utilize shops and store locations and telephone communications in order to conduct business and render said services to users. Such a process typically results in the users or clients waiting for extended periods of time unsure of when he/she will receive their on-person service(s), or who will be conducting said services for them, with very little communication to the user or clientele.

### BRIEF DESCRIPTION OF THE DRAWINGS

FIG. 1 illustrates an example system for enabling a user to request on-demand user-based services using a computing device, under an embodiment.

FIG. 2 illustrates an example method for enabling a user to request on-demand user-based services using a computing device, according to an embodiment.

FIGS. 3A-3M illustrate examples of user interfaces that are displayed to a user to enable the user to request an on-demand user-based service, according to a first and a second embodiment.

FIG. 4 illustrates an example of a user interface that is displayed to a user to enable a user to view and select favorite providers, see what providers are currently trending and popular, according to an embodiment.

FIGS. 5A and 5B illustrate examples of user interfaces that are displayed to a user to enable the user to view past service sessions as well as view past service session details, according to an embodiment.

FIGS. 6A-6C illustrate examples of user interfaces that are displayed to a user to enable the user to edit personal profile information, select and save locations where the user is to be rendered said user-based services, and select and save payment information for the user, according to an embodiment.

FIG. 7 illustrates an example of a user interface that is displayed to a user to enable the user to refer other individuals to utilize the system, choose the method of delivering an invite and view number of accepted and utilized individuals, according to an embodiment.

FIGS. 8A-8E illustrate examples of user interfaces that are displayed to a user to enable the user to view a user-based service provider's summary page or virtual shop, as well as select appointment details, select a payment method, and complete booking of an appointment, according to an embodiment.

FIGS. 9A-9C illustrate examples of user interfaces that are displayed to a user to enable the user to view the status of their appointment, as well as display the user-based service provider's location information and specific appointment details, according to an embodiment.

FIGS. 10A and 10B illustrate examples of user interfaces that are displayed to a user to enable the user to review the user's appointment and experience with the user-based service provider, as well as submit an after photo of the user-based service rendered, according to an embodiment.

FIG. 11 is a block diagram that illustrates a mobile computing device upon which embodiments described herein may be implemented.

### DETAILED DESCRIPTION

Embodiments described herein provide an interactive environment for enabling a user to request on-demand user-based (delivered onto the user's person) services using a computing device. In particular, some embodiments described herein enable mobile computing devices, such as smart phones, smart accessories such as smart watches, and geo-aware cellular telephonic devices, to be used in connection with a user-based on-demand user-based service that enables the user to request services at their location(s), such as barbering, massaging, esthetician services (facials, peels, waxing, tanning, lacing, laser hair removal, etc.), makeup artistry, hair styling, manicuring, and pedicuring, using a simplified user interface schematic. Functionally, such as communicating the location of the user (e.g., where user-based services are to be rendered), the availability and optionally the location of the service providers, the types of services available, details specific to selected providers, fees and pricing information, can be aggregated and provided to the user in an efficient and user-friendly manner.

In one embodiment, a computing device can operate an application for requesting on-demand user-based services. The application can provide user interface features that provide a user of the application with information for enabling the user to request a particular type of user-based service, as well as select a specific provider of said user-based service. For example, the user can be provided a mechanism for selecting user-based services and user-based service types, as well as displaying detailed information that may affect the decision of the user in making such selections.

According to some embodiments, the detailed information and user-based service options made available to the user can be region-specific. For example, different on-demand user-based services and detailed information about different user-based services can be provided to the user based on the region that the user is located in. Thus, the user-based service options made available to the user, as well as the detailed information provided to the user regarding the user-based service options can be made region specific.

In some embodiments, different user interface features can be provided, at least in part, by an application or program that is stored and operated on the user's computing device. The application can be configured to communicate with an on-demand user-based service system that arranges user-based services between users and service providers (e.g., barbers for grooming, masseuses for massaging, estheticians for skin therapy, makeup artists for facial and body makeovers, nail salon workers for manicuring/pedicuring, etc.). For example, a user can request a haircut, beard trim and moustache trim services to be conducted at his or her office, and the on-demand user-based service system can determine available barbers that satisfy the user's request, allow the user to select a specific barber, and arrange for the selected barber to perform the user-based services. The user is enabled, via the user interface features, to make different selections for viewing specified information and for requesting different on-demand user-based service options based on the user selections.

According to an embodiment, a plurality of selection features can be provided, the plurality of selection features includes at least one of: a multi-option selection feature including a plurality of service type selection icons, one of which can be enlarged to indicate selection by the user input of one of the plurality of service type icons; an optional selection feature including a track, and a sliding feature that can be moved amongst multiple positions along the track by the user input to select any one of the plurality of selection states; a location selection feature including a drop down location selection feature which in turn includes location selection options, wherein the location selection options includes a location selection box which can allow a user to input the user-selected location by the user input, a map content, and a cancel selection box; a date time selection feature including a drop down date time selection feature which in turn includes date time selection options, wherein the date time selection options include a calendar date selection feature which includes a plurality of date selection tiles, which can be side-scrolled in order amongst the plurality of date selection tiles by the user input to select one of the plurality of date selection tiles, said selected date selection tile being highlighted to indicate selection, and a time selection feature which includes a plurality of time selection tiles, which can be side-scrolled in order amongst the plurality of time selection tiles by the user input to select one of the plurality of time selection tiles, said selected time selection tile being highlighted to indicate selection; and a first set of selection option features including a plurality of service option selection boxes, each one of the plurality of service option selection boxes individually selectable by the user input to select at least one of the plurality of service option selection boxes, wherein each one of the plurality of service option selection boxes corresponds to a specific service option to be provided to the user by the user-based service provider. The multi-option selection feature can be provided to enable a user to select a particular type of user-based service. In one implementation, the multi-option selection feature identifies a plurality of user-based service types (e.g., barber, esthetician, masseuse, nail salon worker, make-up artist, hair stylist, etc.), optionally the multi-option selection feature is defaulted to only show and select barber. The optional set of selection features, e.g. a slider, can be provided to enable a user to select options specific to the type of user-based service. In one implementation, the optional set of selection features identifies a plurality of user-based service options (e.g., number of user's to receive user-based services, the profession level of the provider of the user-based services, etc.), based on a region where the user is located (e.g. the device's real-time location). A first set of selection option features, e.g. selection boxes, can be provided based on the user's selection of the plurality of user-based service options, to enable a user to select at least one of a plurality of user-based service options, also based on the device's real time location. In one implementation, the first set of selection option features identifies a plurality of user-based services to be rendered to the user (e.g., grooming services to be rendered by a barber: haircut, beard trim, moustache trim, etc.; services to be rendered by an esthetician: facials, peels, waxing, etc.; massage services to be rendered by a masseuse: 60, 90 and 120 minute massage sessions, Swedish, deep tissue, and sports types, etc.; services to be rendered by a nail salon worker: manicure, pedicure, express, classic and deluxe types, etc.; services to be rendered by a make-up artist: makeup application, individual lessons, wedding makeup consultation, eyelash extensions, etc.; services to be rendered by a hair stylist: style, blowdry, chemical blowdry, specialty style, etc.), based on a region where the user is located (e.g. the device's real-time location).

In one embodiment, a summary user interface can be presented on the display in response to the user selecting one of the plurality of user-based service types, such as a barber, esthetician, masseuse, nail salon worker, make-up artist, or hair stylist, optionally selecting one of the plurality of user-based service options, such as one, two, three, or four users, or alternatively, novice, advanced beginner, competent, proficient or expert, and finally selecting at least one of the plurality of user-based services to be rendered to the user, such as haircut, beard trim, moustache trim (in the case that the user is defaulted to or selects the provider to be a barber), and the presented display can be refreshed/updated in response to each individual selection of any one of the selection options. The summary user interface can include region-specific information about the on-demand user-based service that is particular to and based on: the selected service type, the selected user-based service options, and the selected user-based services to be rendered. For example, for a barbering user-based service, the summary user interface can include region-specific information about the closest barbers, names and brief descriptions of said barbers available in the region, the category of pricing for the barber's grooming and haircut services (e.g. between one and four dollar signs), the number of barbers available, whether or not the barber is a favorite, number of stars based on reviews of the barber, etc. In another example, the region-specific information can include name of barbers available, an estimated distance (in time) until arrival to the user's current location, the category of pricing for the barber's grooming and haircut services (e.g. between one and four dollar signs), the barbers specialty services, etc. The provided information can assist the user in making a better-informed decision in requesting the on-demand user-based service. In some implementations, the user can interact with the multi-option selection feature and the first and first sets of selection features by selecting different user-based service types and/or user-based service options to cause the contents within the summary user interface to dynamically change accordingly.

Still further, in some embodiments, once the user requests the on-demand user-based service based on the selection of at least one of: a user-based service type, a profession level of the user-based service provider, a date and time to render the user-based service, a user-based service location, or a specific service to be provided, several different user interface features can be displayed to the user including: an individual service provider interface feature/a user-based service provider virtual shop interface feature, a booking user interface feature, a confirmation user interface feature, a booking/appointment status user interface feature. The confirmation user interface feature can be displayed to present additional features and information that the user can verify before confirming the request, the optional set of selection features can also be displayed on the confirmation interface instead of on/prior to the summary user interface (e.g., number of user's to receive user-based services). When the user confirms the request (e.g., places an order), the computing device can provide the service request to the on-demand user-based service system with necessary user data so that the on-demand user-based service system can arrange the service between the user and the selected service provider. The user can provide additional information on the confirmation user interface feature, such as, for example, the specified location at which the user demands the services be rendered at (defaulted to the user's default location, i.e. current location, home location, etc.), the optional set of selection features including the number of people to receive the services (defaulted to one), which services the user is specifically requesting (e.g. hair cut, beard trim, moustache trim, etc.), special notes for the service provider, a promotional code and the selected payment method (defaulted to the user's default payment method) before confirming the request. The user-based service provider virtual shop user interface can include the user-based service provider information and additional user-based service provider information that is specific to the user-based service provider associated with the selected individual service provider selection panel, the additional user-based service provider information including a user-based service provider image portfolio, a user-based service provider professional license number and licensed state, a user-based service provider specialties description, and a detailed reviews listing. The booking/appointment status user interface can include a map that (i) indicates the current location of the computing device, and (ii) a graphic feature that represents a current location of a selected user-based service provider, the graphic feature is moved on the map to reflect movement of the selected user-based service provider.

As described herein, a “user,” or a “customer” refer to individuals that are requesting or ordering an on-demand user-based service. Also as described herein, a “provider”, a “service provider” or a “user-based service provider” refer to individuals or entities that can provide the requested service. As described herein, a “user-based service” is defined as a service that is rendered onto a user's body. As an example, a user can request an on-demand user-based service (e.g., grooming, massaging, skin therapy, facial and body makeovers, manicuring/pedicuring, etc.) using the system, and a service provider can communicate with the system and/or the user to arrange to perform the user-based service. In addition, as described herein, “customer devices” and “provider devices” refer to computing devices that can correspond to desktop computers, cellular or smartphones, cellular or smartphone accessories (connected smart watches), cellular smart watches, personal digital assistants (PDAs), laptop computers, tablet devices, television (IP Television), etc., that can provide network connectivity and processing resources for enabling a user to communicate with a system over a network. A provider device can also correspond to service scheduling/transaction devices and other scheduling/transaction devices.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, cellular or smartphone accessories (connected smart watches), cellular smart watches, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives or flash storage on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones and accessories therewith e.g. smart watches) are all examples of machines and devices that utilize processors, memory, and instructions stored on computer-readable mediums. Additionally, embodiments may be implemented in the form of computer-programs, or a computer usable carrier medium capable of carrying such a program.

System Description

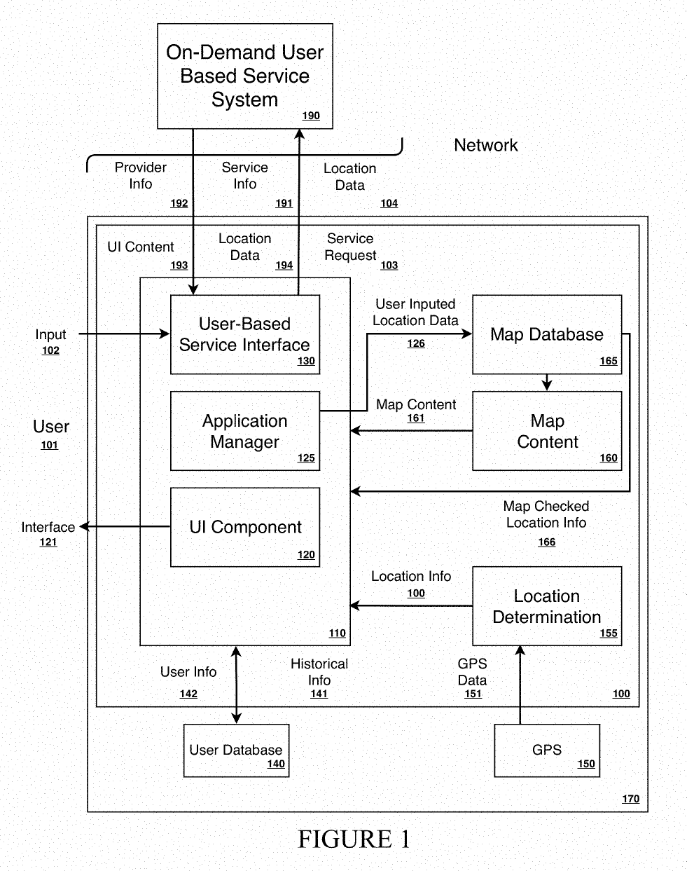

FIG. 1 illustrates an example on-demand user-based service user interface system, under an embodiment. According to some embodiments, system 100 can be implemented through software that operates on a portable computing device, such as a mobile computing device 170. System 100 can be configured to communicate with one or more network services that coordinate or otherwise provide on-demand user-based services. Additionally, the mobile computing device can include inherent or native functionality, and can utilize third-party services which enable further functionality through system 100.

As an alternative or addition, some or all of the components of system 100 can be implemented on one or more computing devices, such as on one or more servers or other mobile computing devices. System 100 can also be implemented through other computer systems in alternative architectures (e.g., peer-to-peer networks, etc.). Accordingly, system 100 can use data provided by an on-demand user-based service system, data provided by other components of the mobile computing device, and information provided by a user in order to present user interface features and functionality for enabling the user to request an on-demand user-based service. The user interface features can be specific to the location or region that the computing device is located in, so that region-specific information can be provided to the user. System 100 can also adjust the user interface features, including the content displayed as part of the user interface features, based on other user selections.

In some implementations, system 100 includes an on-demand user-based service application 110, a map component 160, a map database 165, and a location determination 155. The components of system 100 can combine to provide user interface features that are specific to user selections, user locality, and/or real-time conditions to enable a user to request on-demand user-based services. The on-demand user-based service application 110 can correspond to a program that is downloaded onto a smartphone (including a smartphone accessory such as connected smart watch), smart watch, or portable computer device (e.g., tablet or other ego-aware device). In one implementation, a user can download and install the on-demand user-based service application 110 on his or her computing device and register the computing device 170 with an on-demand user-based service system of the entity.

The on-demand user-based service application 110 can include an application manager 125, a user interface (UI) component 120, and a user-based service interface 130. The user-based service interface 130 can be used to handle communications exchanged between the on-demand user-based service application 110 and the on-demand user-based service system 190 (e.g., over a network). For example, the user-based service interface 130 can use one or more network resources of the device 170 for exchanging communications over a wireless network. The network resources can include, for example, a cellular data/voice interface to enable the device to receive and send network communications over a cellular transport. As an alternative or variation, the network resources can include a wireless network interface for connecting to access points (e.g., Wireless Fidelity 802.11(g) or 802.11(n)) or for using other types of wireless mediums (e.g., WiMax)

The application manager 130 can receive user input 102 from a user 101, location information 156, and other information (such as user information 142 and/or historical information 141) to configure content that is to be provided by the UI component 120. For example, the UI component 120 can cause various user interface features 121 to be output to a user 101 via a display of the computing device 170. Some of the user interface features 121 can be region-specific (e.g., based on the current location of the computing device) to display information that is particular to the region. The user interface features 121 can also provide dynamically adjusted content based on user selections provided by the user 101 via the user input 102.

For example, the UI component 120 uses a UI framework that can be configured with various content, such as UI content 193 provided by the on-demand user-based service system 190 and content as a result of user input. The UI component 120 can also configure the UI framework with location information 156, map content 161 and/or map checked location info 166 based on user inputted location data 126 that has been checked/verified by the map database 165. In this manner, a map of a region in which the user is currently located and/or the location that the user has inputted in can be displayed as part of a user interface feature 121. In some examples, the map component 160 can provide the map content 161 using map data stored in one or more map databases 165. Based on the locale of the user and the user selection(s) made for requesting an on-demand user-based service, such as a user-based service type that the user would like to receive, the application manager 125 can cause region-specific and user-selection-specific UI content 193 to be presented with or as part of a user interface 121.

In some implementations, the user interfaces 121 can be configured by the application manager 125 to display information about on-demand user-based services that are available for the user-specific region. On-demand user-based services can include barber grooming services (e.g., users can request haircuts, beard trims, moustache trims, etc.), esthetician skin therapy services (e.g., facials, peels, waxing, etc.), masseuse massaging services (e.g., 60, 90 and 120 minute massage sessions, Swedish, deep tissue, and sports types, etc.), nail grooming services (e.g., manicure, pedicure, express, classic and deluxe types, etc.), makeup artist services (e.g., makeup application, individual lessons, wedding makeup consultation, eyelash extensions, etc.), hair stylist services (e.g., style, blowdry, chemical blowdry, specialty style, etc.), or other user-based services that the user can request via the on-demand user-based service system. Based on the user's region, different services and service options can be available for the user.

For example, for an on-demand barber service, certain barbers may be available in one city, and unavailable in another. Similarly, barber specialties may be available in one city, and unavailable in another. In another example, for an esthetician service, an on-demand Brazilian wax may be available in one country or region, and may not be available in other countries. In various examples described, the user interfaces 121, which display information about user-based services available for a user, as well as features to enable the user to request user-based services, can be configured with network user interface content (e.g., provided by the on-demand user-based service system 190) to reflect the services available to the user based on the user's geographic region. The user 101 is enabled to interact with the different displayed user interface features 121, via the user input 102, to make selections and input preferences when requesting an on-demand user-based service from the on-demand user-based service system 190.

When the on-demand user-based service application 110 is operated by the user 101, the various user interfaces 121 can be rendered to the user 101 based on the user inputs 102 and/or information received from the on-demand user-based service system 190. These user interfaces include, for example, a home page user interface (e.g., an initial page or launch page), a multi-option selection feature, an optional set of selection features, a first set of selection option features, a summary user interface, a location suggestion user interface, a location search user interface, a confirmation user interface, individual service provider user interface, a virtual provider shop user interface, a gifts and referrals user interface, a favorites and trending user-based services user interface, a past sessions user interface, a booking/appointment status user interface, a booking user interface, or a combination of any of the features described. For example, the UI component 120 can cause a home page user interface 121 to be displayed that identifies the service(s) that the user can request using the on-demand user-based service application 110. The home page user interface 121 can also provide only certain service selection options or types that are available in the user's region (with the unavailable selection options greyed out or unselectable). In this manner, based on the current location of the computing device, or optionally the user inputted and checked location, the on-demand user-based service application 110 can cause location-specific user interfaces 121 and content to be presented to the user.

In many instances, a geographic region that is specific to the user can be based on the user's current location (e.g., the current location of the computing device 170) or the user's requested service location (e.g., the home of the user, the workplace of a user, or a property owned by the user, inputted by the user 101 via user input 102 checked by the map database 165 and returned as map checked location information 166). For example, in some cases, the current location can be different from the requested service location, so that the user can manually select a particular on-site user-based service location that is different from the current location of the computing device 170. The user's current location or service performance location can be determined by the location determination 155 or by checking the user inputted location data 126 against the map database 165.

The location determination 155 can determine the location of the computing device in different ways. In one example, the location determination 155 can receive global positioning system (GPS) data 151 from location-based/geo-aware resources 150 of the computing device 170. In addition, the location determination 155 can also receive GPS data 151 from other applications or programs that operate on the computing device 170. For example, system 100 can communicate with one or more other applications using one or more application program interfaces (APIs). The on-demand user-based service application 110 can use the location information 156 or the map checked location information 166 to cause the UI component 120 to configure the UI framework based on the location information 156 or the map checked location information 166. In addition, the on-demand user-based service application 110 can provide the user's location data 104 to the on-demand user-based service system 190.

As an addition or alternative, the on-demand user-based service application 110 can determine the user's current location or requested service location (i) by using location data 194 provided by the on-demand user-based service system 190, (ii) by using map checked location information 166 based on the user location input provided by the user 101 (via a user input 102), and/or (iii) by using user info 142 and/or historical info 141 stored in one or more user databases 140.

For example, the on-demand user-based service system 190 can cross-reference the location data 104 (received from the on-demand user-based service application 110) with the other sources or databases (e.g., third party servers and systems) that maintain location information to obtain granular/specific data about the particular identified location. In some cases, by cross-referencing the data, the on-demand user-based service system 190 can identify particular offices, apartment complexes, venues, street addresses, etc., that are proximate to and/or located at the identified location, and provide this information as location data 194 to the on-demand user-based service application 110. The application manager 125 can cause the UI component 120 to provide the specific location information as part of the user interface 121 so that the user can select a particular street address as the current location or the service performance location (e.g., the user's home, workplace or owned property).

The on-demand user-based service application 110 can also receive user location input provided by the user to determine the current location or service location of the user. In one example, the on-demand user-based service application 110 can cause the UI component 120 to present a location search user interface on the display. The user can input a search term to identify offices, venues, addresses, etc., that the user wishes to request the on-demand user-based service. The on-demand user-based service application 110 can perform the search by querying one or more external sources to provide the search results to the user. In some variations, the user can manually provide user location input by entering an address (e.g., with a number, street, city, state) or by manipulating and moving a service location graphic/icon on a map that is displayed as part of a user interface 121. In response to the user selection, the on-demand user-based service application 110 can provide the location data 104 to the on-demand user-based service system 190.

In another variation, the on-demand user-based service application 110 can retrieve and use user information 142 and/or historical information 141 that are stored in a user database 140. The user database 140 can include records of the user's previous on-demand user-based service requests as well as user preferences. In some implementations, the user database 140 can be stored remotely at the on-demand user-based service system 190 and user information can be retrieved from the on-demand user-based service system 190. The on-demand user-based service application 110 can use the data stored in the user database 140 to identify previous service locations for the user (e.g., a barbering application 110 can access the user database 140 for records of when the user last ordered a haircut and where the user had the barber conduct the last haircut, e.g., user's home, workplace, or other owned property). Based, in part, on the current location of the computing device 170, the on-demand user-based service application 110 can use the user information 142, such as the user's home address, the user's place of business, the user's preferences, etc., and historical information 141, such as the frequency and recency of previous locations that the user requested services at, to provide recent and/or recommended points of interest to the user. When the user selects one of the entries of a recommended point of interest as a current location and/or on-site user-based service location, the on-demand user-based service application 110 can provide the location data 104 to the on-demand user-based service system 190.

Based on the user's current location or on-site user-based service location, the application manager 125 can cause region-specific user interface features 121 to be outputted by the UI component 120. A region that is specific to the user includes the current location (or on-site user-based service location) in which on-demand user-based services can be provided to the user. The region can be a city or metropolitan area in which the computing device 170 is currently located in, can be an area having a predetermined distance radius from current location (e.g., six miles), or can be an area that is specifically partitioned from other areas. Based on the user's region, the application manager 125 can cause region-specific information about the on-demand user-based service to be provided on one or more user interface features 121.

Region-specific information about the on-demand user-based service can be provided, in part, by the on-demand user-based service system 190. As discussed, the on-demand user-based service application 110 can provide location information to the on-demand user-based service system 190 so that the on-demand user-based service system 190 can arrange for an on-site user-based service to be provided to a user 101 (e.g., arrange a haircut or massage to be done on the user). Based on the user-specified region, the on-demand user-based service system 190 can provide information about available user-based service providers (e.g., barbers, masseuses) that can perform the on-demand user-based service in that region.

For example, for a barber service, a barber on-demand user-based service system 190 can maintain information about the number of available barbers, the details of available barbers, which barbers are currently performing a grooming service, which barbers are ready to render their grooming services to users, the current location of the barbers, the direction and destination of the barbers in motion, etc., in order to properly arrange the barber service between users and barbers. In another example, for a massaging service, a masseuse on-demand user-based service system 190 can maintain information about the different masseuses that are available, where the masseuses are, how long a masseuse will be at a particular location, what type of massage therapies are being served, etc. Because services can vary between regions, such as cities, the application manager 125 can cause only information pertinent to the user's specific region to be provided as part of the user interface 121.

Using the information maintained about the user-based services and the user-based service providers, the on-demand user-based service system 190 can provide relevant information to the on-demand user-based service application 110. Service information 191 can correspond to information about the particular on-demand user-based service that can be arranged by the on-demand user-based service system 190 (e.g., barber grooming services, masseuse massaging services, nail grooming services, makeup artist services, or hair stylist services). Service information 191 can include information about costs for the user-based service, available user-based service options (e.g., types of grooming available, types of massages, haircutting options), or other details (e.g., available times, specials, etc.). Provider information 192 can correspond to information about the available user-based service providers themselves, such as profile information about the providers, the current location or activity of the providers recent user-based service (e.g., types of haircuts, beard trims or moustache trims conducted with images corresponding to them), specific grooming that the barber is proficient at, current rating of the barber, etc., or the types of grooming.

Referring back to the example of an on-demand barbering service, if the user requests grooming in San Francisco, Calif., the on-demand user-based service system 190 would look for available barbers within a particular distance or particular on-site arrival time from the user (e.g., the system would not consider barbers in Los Angeles, Calif.). The on-demand user-based service system 190 can transmit relevant service information 191 (e.g., cost for the service, promotions in the area) and relevant provider information 192 (e.g., barber information, trending information) to the on-demand user-based service application 110 so that the on-demand user-based service application 110 can cause region-specific information to be presented to the user. For any type of on-demand user-based service, the on-demand user-based service system 190 can transmit service information 191 and/or service provider information 192 to the on-demand user-based service application 110.

As an example, a region-specific user interface feature 121 can include at least one of a plurality of selection features including: a multi-option selection panel, an optional set of selection features panel, a location/date/time selection feature, with a location info/selection feature and a date/time selection feature, a user-based service provider selection feature, a display page selection feature/panel, and a first set of selection option features panel. The multi-option selection panel can include a multi-option selection feature that can be manipulated and moved by the user (e.g., by interacting with an input mechanism or a touch-sensitive display screen) in order to optionally select one of a plurality of user-based service types to request the specific type of on-demand user-based service. Based on the user's determined region, the multi-option selection panel can identify and display only certain options that are available for providing the on-demand user-based service types in that region (in the case that there is only one user-based service type in that region the selection feature is defaulted to that service type). The optional set of selection features panel can include an optional set of selection features that can be manipulated and selected/highlighted by the user (e.g., by interacting with an input mechanism or a touch-sensitive display screen) in order to select one of a plurality of user-based service level options to request the specific level of on-demand user-based service. Based on the user's determined region, and optionally the user's selection in the multi-option selection panel, the user's selection in the optional set of selection features panel can identify and display only certain options that are available for providing the on-demand user-based service levels in that region. The first set of selection option features panel can include a first set of selection option features that can be manipulated and selected/highlighted by the user (e.g., by interacting with an input mechanism or a touch-sensitive display screen) in order to select at least one of a plurality of user-based service options to request the specific options of on-demand user-based service. Based on the user's determined region, optionally the user's selection, in the multi-option selection panel, and optionally the user's selection in the optional set of selection features panel, and the user's selection(s) in the first set of selection option features panel, can identify and display only certain options that are available for providing the on-demand user-based service options in that region. For an on-demand barbering service, for example, if novice or advanced beginner profession levels are unavailable in a particular region, such as San Francisco, but Competent, Proficient, and Expert levels of profession are available, the optional set of selection features panel can enable only the available profession levels to be displayed and/or selected by the user 101. The indicators for the unavailable profession levels, such as novice and advanced beginner, for example, can be blocked out, hidden, or displayed in a different manner than indicators for profession levels that are available in that region.

Similarly, in an example for on-demand massaging, the first set of selection option features panel can provide different massaging service options that are available for selection by a user 101 in the region. If a Swedish type massage is unavailable for a particular region, while deep tissue type, 120 minute duration, or sports type are available for a user 101 to request, the first set of selection option features panel can enable only deep tissue type, 120 minute duration, and/or sports type to be selected by the user 101 in requesting the on-demand massage service.

When the user interacts with the first set of selection options, additional information corresponding to the selected service option can be provided in a region-specific user interface feature 121. In one implementation, the user interface feature 121 can correspond to a summary panel that displays region-specific information about the selected service option(s). For example, for an on-demand massage service, once a user makes a selection of a type of service (e.g., a type of massage, or a duration of the massage, etc.), the summary panel can display information about the closest available massage provider (masseuse), the average cost for a massage service (displayed in dollar signs), massage details, service provider profile information, or other information that the user can quickly view to make an informed decision.

In another example, for an on-demand barbering service, the summary panel can provide region-specific information, such as the estimated distance away, in time, of a barber (based on the user's current location or on-site service location and the current locations of the available barbers capable of delivering the selected service options chosen by the user), the average haircut, beard trim, or moustache service price (displayed as dollar signs) based on the barber's region/services (e.g., the average estimated grooming cost can be region-specific because some regions can be more expensive than other regions and/or some grooming service types can be more expensive than other grooming service types), and the skill level of the barber (how many years of experience there barber has, the specialties that the barber is capable of conducting, etc.). In one variation, the summary panel can be provided concurrently with all of the plurality of selection features so that when the user manipulates/chooses at least one of: a user-based service type, a profession level of the user-based service provider, a date and time to render the user-based service, a user-based service location, or a specific service to be provided, the content within the summary panel can be dynamically adjusted by the on-demand user-based service application 110 to provide updated information corresponding to the selected option(s). In another variation, prior to the dynamic updating after the user's selection of the service type, optional set of selection options and at least one of the plurality of selection options, there can be a delay in order to give the user a chance to select a different one of the selection options, etc.

Once the user makes at least one selection by providing a user input 102, the application manager 125 can cause the UI component 120 to provide user interface features 121 that are based on the selected service option(s). The user can then make a request for the on-demand user-based service based on the selection(s). In one example, when the user makes a request, a confirmation user interface feature 121 can be provided by the on-demand user-based service application 110. From this user interface feature, the user can view the details of the request, such as what location the user-based service(s) is/are to be rendered (e.g., the user's current location, the user's map checked inputted location, or one of the user's saved locations), how many user's are to receive the service(s) (in this case the optional set of selection features panel would be presented within the confirmation user interface), which specific service(s) have been chosen/requested, gratuity amounts for the service provider, what account or credit card to charge (and can edit or choose a different payment method), provide specific requests to the service provider, enter a promotional code for a discount, calculate the price, cancel the request, or confirm the request. As an alternative, the request can be automatically confirmed without displaying a confirmation user interface feature 121.

After the user confirms the request for the on-demand user-based service, the on-demand user-based service application 110 can provide the service request 103 to the on-demand user-based service system 190 via the user-based service interface 130. In some examples, the service request 103 can include the service location specified by the user (e.g., the location where the user would like the service to be performed or provided), the user's account information, the selected service option(s), any specific notes or requests to the service provider, and/or other information provided by the user. Based on the received service request 103, the on-demand user-based service system 190 can arrange the service between the user and selected user-based service provider that is qualified and capable of providing the on-demand user-based service. The on-demand user-based service system 190 can provide additional provider information 192 to the on-demand user-based service application 110, such as the particulars of the selected user-based service provider, the service provider's virtual shop, etc., so that this information can be provided to the user 101 on a user interface 121.

Methodology

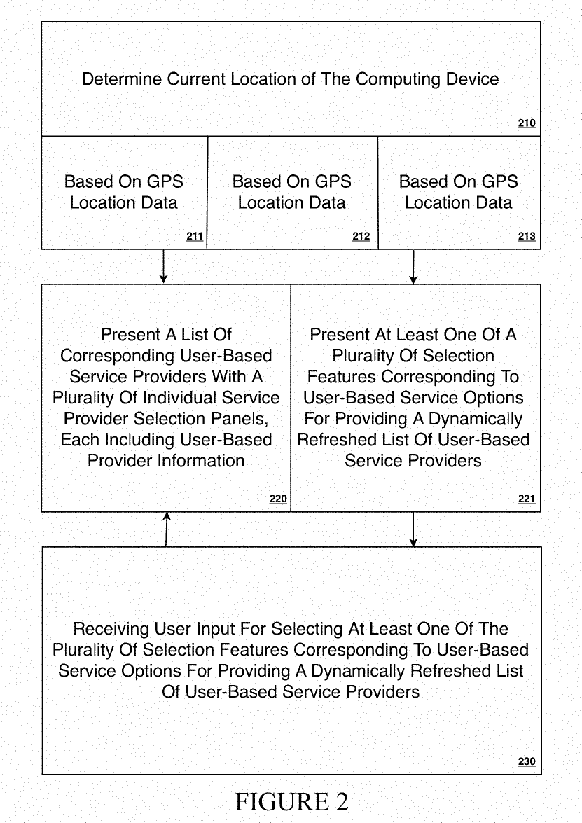

FIG. 2 illustrates an example method for providing on-demand user-based service user interface features on a computing device, according to an embodiment. A method such as described by an embodiment of FIG. 2 can be implemented using, for example, components described with an embodiment of FIG. 1. Accordingly, references made to elements of FIG. 1 are for purposes of illustrating a suitable element or component for performing a step or sub-step being described.

The on-demand user-based service application can automatically determine the current location of the computing device (step 210). According to different implementations, the current location of the computing device (or the selected service location for the on-demand user-based service) can be determined based on location data provided by a geo-aware resource, such as a GPS component of the computing device (sub-step 211), based on map database checked user input to search and/or select particular locations (sub-step 212), and/or based on historical data of previous on-site locations of the user (sub-step 213). Using the current location or the service location of the user, a region or area (that includes the current location or the on-site service location) in which the on-demand user-based services are to be performed can be determined by the on-demand user-based service application and/or the on-demand user-based service system. In this manner, the on-demand user-based service system can identify available service providers (e.g., barbers, estheticians, masseuses, nail groomers, makeup artists, hair stylists) in the region that can perform the on-demand user-based service.

Based on the determined region and/or the determined current location or service location, presenting to the user, via display, both a list of corresponding user-based service providers with a plurality of individual service provider selection panels, each including user-based service provider information, the user-based service provider information including: a profile/cover photo of the user-based service provider, a name of the user-based service provider, a favorites indicator, a rating score of the user-based service provider, a cost category indicator and a brief description of the user-based service provider (step 220), and at least one of a plurality of selection features including: a multi-option selection feature including a plurality of service type selection icons, one of which can be enlarged to indicate selection by the user input of one of the plurality of service type icons; an optional selection feature including a track, and a sliding feature that can be moved amongst multiple positions along the track by the user input to select any one of the plurality of selection states; a location selection feature including a drop down location selection feature which in turn includes location selection options, wherein the location selection options includes a location selection box which can allow a user to input the user-selected location by the user input, a map content, and a cancel selection box; a date time selection feature including a drop down date time selection feature which in turn includes date time selection options, wherein the date time selection options include a calendar date selection feature which includes a plurality of date selection tiles, which can be side-scrolled in order amongst the plurality of date selection tiles by the user input to select one of the plurality of date selection tiles, said selected date selection tile being highlighted to indicate selection, and a time selection feature which includes a plurality of time selection tiles, which can be side-scrolled in order amongst the plurality of time selection tiles by the user input to select one of the plurality of time selection tiles, said selected time selection tile being highlighted to indicate selection; and a first set of selection option features including a plurality of service option selection boxes, each one of the plurality of service option selection boxes individually selectable by the user input to select at least one of the plurality of service option selection boxes, wherein each one of the plurality of service option selection boxes corresponds to a specific service option to be provided to the user by the user-based service provider (step 221).

The multi-option selection feature can identify, and enable a user to select one of various available types of on-demand user-based service. For example, the multi-option selection feature can identify the specific type of user-based services that are available in the user's determined region (e.g., barber, esthetician, masseuse, nail salon worker, make-up artist, hair stylist, etc.) that the user can request services from. The multi-option selection feature identifies only those user-based types that are available in that region to provide the on-demand user-based service, so that user-based service types that are unavailable cannot be selected by the user, or can be defaulted to only show one user-based service type, such as barber. For example, in one region, such as a particular city, only barbers and estheticians may be available, whereas in another city, barbers, hair stylists, and masseuses may be available for providing services. The optional selection feature can identify, and enable a user to select one of various on-demand user-based service options. For example, the optional selection feature can identify the profession level of the service provider, or the number of users to receive services from the user-based service provider, that are available in the user's determined region. The optional selection feature identifies only the user-based service providers of profession levels that are available in that region to provide the on-demand user-based service, so that profession levels of the user-based service providers that are unavailable cannot be selected by the user. For example, in one region, such as a particular city, only barbers and estheticians of the profession level expert, proficient and novice may be available, whereas in another city, barbers and estheticians of the profession levels advanced beginner, competent and proficient may be available for providing services. The first set of selection option features can identify, and enable a user to select at least one of various on-demand user-based service options. For example, the first set of selection option features can identify the specific services, that the user-based service provider provides, that are available in the user's determined region. The first set of selection option features identifies only the specific services, to be provided by the user-based service provider, that are available in that region, so that services of the user-based service providers that are unavailable cannot be selected by the user. For example, in one region, such as a particular city, only the specific services (of a barber) haircut and beard trim may be available, whereas in another city, the specific services haircut, beard trim and moustache trim may be available for providing services.

The date and time selection feature is defaulted to the current date and time of the user's viewing, and the location info/selection feature is defaulted to the user's GPS determined location or user-set default location (as determined in step 210), on the display of the computing device (sub-step 212). The date and time selection feature can identify, and enable a user to select a future date and time based on the user's own schedule, on which to request services from a provider (of the selected user-based service type). For example, the date and time selection feature can identify the specific user-based service providers that are available in the user's determined region, at the user's selected date and time (e.g., barbers that are available in the user's region on Tuesday at 11:00 AM PST, Monday at 4:00 PM PST, etc.). The date and time selection feature identifies only those user-based service providers (selected via the multi-option selection feature, or defaulted to a single user-based service provider, e.g., barbers) that are available in that region at the selected date and time to provide user-based service, so that user-based service providers that are unavailable at that date and time cannot be selected by the user. For example, at one date and time, in one region, such as a particular city, only specific barbers or estheticians may be available to provide services, whereas on another date and time, in the particular city, a different set of barbers or estheticians may be available to provide services.

The user is enabled to interact with at least one of the plurality of selection features, via a user input, in order to make a selection of at least one of a plurality of selection icons, states, boxes, or tiles being associated with a corresponding user-based service option, the user based service options including a user-based service type, a profession level of the user-based service provider, a number of users to receive the specific service, a user-selected location, a user-selected date and time, and at least one specific service to be rendered (step 230). In one example, the multi-option selection feature that is displayed to the user can be an icon panel with a selectable icon that is enlarged when selected to show as larger than the other icons. In other variations, the multi-option selection feature can include a selectable icon that can slide along a track to select one of the different available service types in that region. For example, on a mobile computing device with a touch-sensitive display, the user can tap on the different service types to cause the selectable icon to enlarge the selected service type or hold and drag the selectable icon between the different service types along a track or path. In the instance that the multi-option selection feature is not defaulted to on service type (e.g. barber), when the user designates the selectable icon or moves the selectable icon between the different service types, the remaining portions of the display are modified/updated to display information corresponding to the selected service type (e.g. when barber is selected, information regarding available barbers in the user's region is displayed). In one example, the optional selection feature that is displayed to the user can be a slider panel with a selectable icon that can slide along a track. In other variations, the optional selection feature can include features to toggle on or off each of the different available service options in that region. For example, on a mobile computing device with a touch-sensitive display, the user can tap on the different service options to cause the selectable icon to move to the selected option, or hold and drag the selectable icon between the different service options along a track or path. In the instance that the optional selection feature is not presented at the confirmation user interface (e.g. is included), when the user moves the selectable icon between the different service options, the remaining portions of the display are again modified/updated to display information corresponding to the selected service option (e.g. when the profession level of novice is selected, only barbers in that region with the profession level of novice are displayed, when the number of users to receive service is selected as two, only barbers in that region capable of rendering service to two users are displayed). In one example, the first set of selection option features that is displayed to the user can be a plurality of selection boxes.

In other variations, the first set of selection option features can include features to toggle on or off each of the different available services to be rendered in that region. For example, on a mobile computing device with a touch-sensitive display, the user can tap on the different selection boxes indicating the services to be rendered to cause the selection boxes to become highlighted or to otherwise indicate selection, or by placing a check within the service selection boxes that are selected. In one instance, when the user selects at least one of the service selection boxes, the remaining portions of the display are again modified/updated to display information corresponding to the selected services to be rendered to the user (e.g. when the selected services are haircut and beard trim, only barbers in that region with the capability of cutting hair and trimming beards are displayed).

Once the user makes a selection of one or more of the plurality of selection options including a user-based service type, a profession level of the user-based service provider, a number of users to receive the specific service, a user-selected location, a user-selected date and time, and at least one specific service to be rendered, the application displays user interface features that are region-specific and selection-specific. In one implementation, a region-specific summary user interface is presented based on the selected user-based service type, profession level of the user-based service provider, number of users to receive the specific service, user-selected location, user-selected date and time, and at least one specific service to be rendered (step 240). The summary user interface can be region-specific because different regions can have different pricing structures based on usage of the service in the city, the amount of available service providers and/or users, the overall cost of living, etc. The summary user interface can provide a variety of region-specific and selection-specific content to the user so that the user can specify the type of service and service options he or she prefers.

The summary user interface including the list of corresponding user-based service providers can be dynamically refreshed in response to receiving, in connection with the plurality of selection features, a second user input to select a second of at least one of the plurality of selection icons, states, boxes, or tiles, to provide the list of corresponding user-based service providers associated with the second selected at least one of the plurality of selection icons, states, boxes, or tiles, including the plurality of individual service provider selection panels, each including user-based service provider information that is specific to the user-based service provider associated with the corresponding individual service provider selection panel, the user-based service provider information including the profile/cover photo of the user-based service provider, the name of the user-based service provider; the favorites indicator, the rating score of the user-based service provider; and the brief description of the user-based service provider. Additionally, the user interface can receive one of a user input for a selection of one of the plurality of individual service provider selection panels and a quick book user input associated with a swiping feature or a special touch feature (a special touch feature is defined as the following: a multi-touch, a 3D touch, or a force-touch) for a quick book selection of one of the plurality of individual service provider selection panels; and in response to receiving the user input for the selection of the individual service provider selection panel, presenting a user-based service provider virtual shop user interface on the display; or in response to receiving the quick book user input for the quick book selection of the individual service provider selection panel, presenting a booking user interface on the display. Upon receiving a quick book selection of one of the plurality of individual service provider selection panels, at least one of the plurality of selection features are presented as part of the booking user interface, and wherein the booking user interface includes additional user-based service provider information and provides a continue booking request feature that can be selected by the user to request an on-demand user-based service using the user-based service option associated with the selected icons, states, boxes, or tiles.

Upon receiving a user input, by the user, for a selection of the continue booking request feature, which is presented as part of the booking user interface; and in response to receiving the user input for the selection of the continue booking request feature, the user is presented, on the display, with a confirmation user interface on the display. The confirmation user interface provides service-specific information about the user-based service option associated with the selected icons, states, boxes, or tiles with which the service request feature of the selection is provided, and provides a complete booking service request feature, the service-specific information including at least one of the current location or user-selected location of the computing device, cost information, account information of the user used to pay for the user-based on-demand service, or information about a user-based service provider that is providing the user-based service option associated with the selected icons, states, boxes, or tiles. Upon receiving a user input for a selection of the complete booking service request feature; and in response to receiving the user input for the selection of the complete booking service request feature, presenting a booking status user interface on the display. The booking status user interface can includes a map that (i) indicates the current location of the computing device, and (ii) a graphic feature that represents a current location of a selected user-based service provider of the user-based service option associated with the selected icons, states, boxes, or tiles. The graphic feature that represents a current location of the selected user-based service provider can move on the map to reflect movement of the selected user-based service provider.

Alternatively, when the user selects an individual service provider panel, via a user input, the user-based service provider virtual shop is presented to the user, via the display. The user-based service provider virtual shop includes the user-based service provider information and additional user-based service provider information that is specific to the user-based service provider associated with the selected individual service provider selection panel, the additional user-based service provider information including a user-based service provider image portfolio, a user-based service provider professional license number and licensed state, a user-based service provider specialties description, and a detailed reviews listing. The user-based service provider virtual shop can also provide a booking request feature that can be selected by the user to request an on-demand user-based service using the user-based service option associated with the selected icons, states, boxes, or tiles.

Again, referring to the on-demand barbering service example, the summary user interface can identify a list of available barbers including the barbers profile/cover photo, the barber's name, a favorites indicator, a rating score of the barber, a cost category indicator of the barber, and brief description of the barber, etc. The summary user interface can also display the plurality of selection feature panels (at a top portion) including: the multi-option selection panel; the location info/selection panel; the date/time selection panel; and the first set of selection options panel, as well as the display page selection panel (at a bottom portion).

In some implementations, the summary user interface can also be displayed concurrently with the plurality of selection features so that when the user changes the selected set of user-based service options to select a different set of user-based service option, the summary user interface, including the list of corresponding user-based service providers can dynamically alter the content based on the adjusted selections. In this manner, the user can easily view the differences (e.g., differences in available user-based service providers) between the sets of user-based service options to make a better judgment on what on-demand user-based service options to request.

User Interface Examples

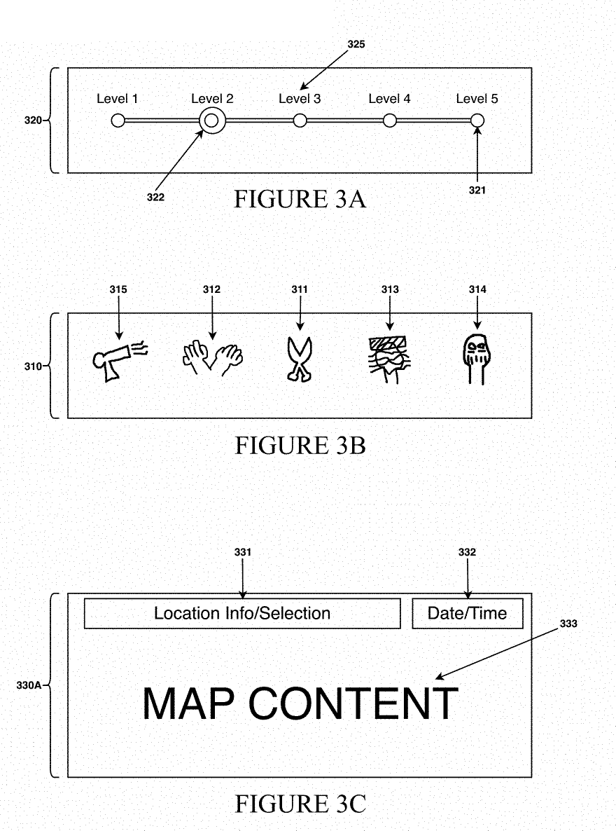

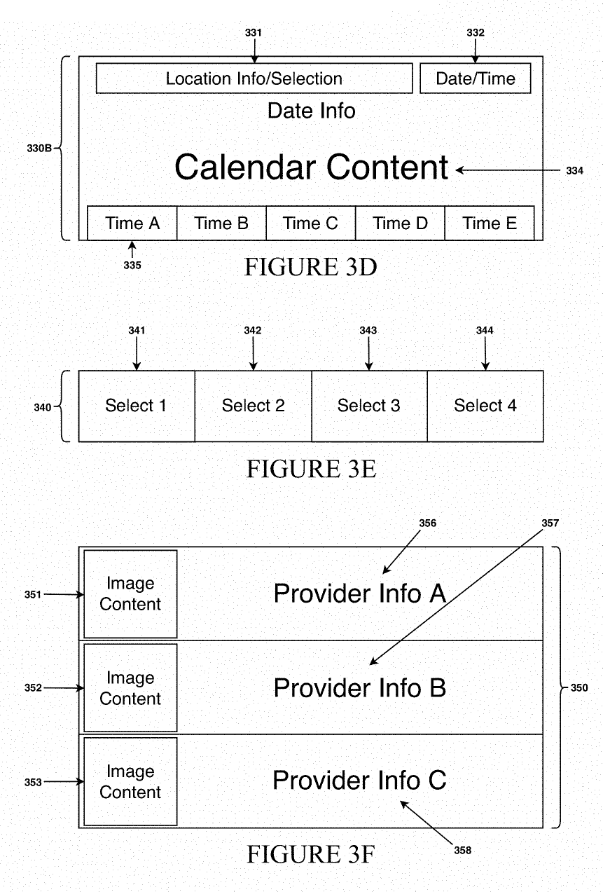

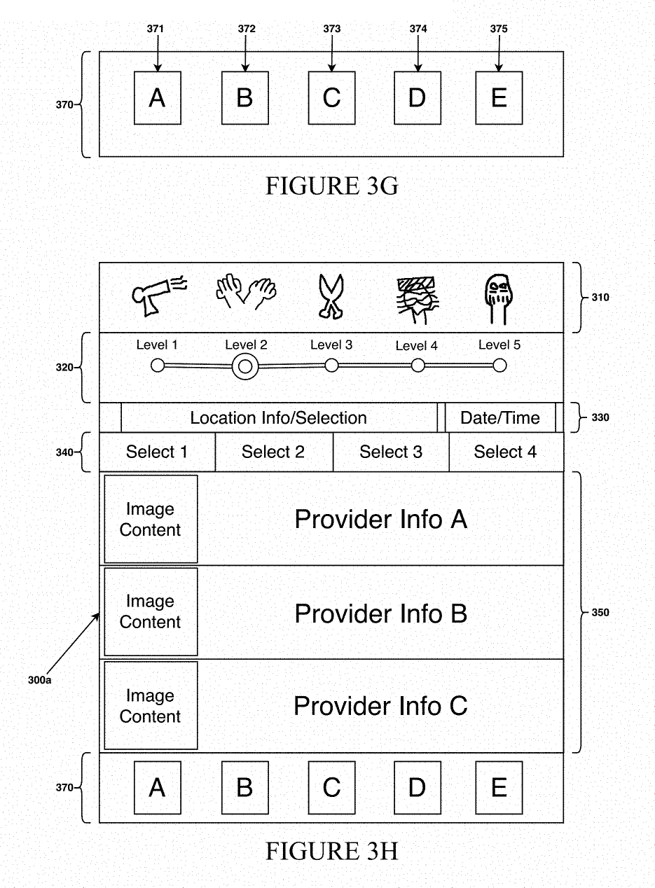

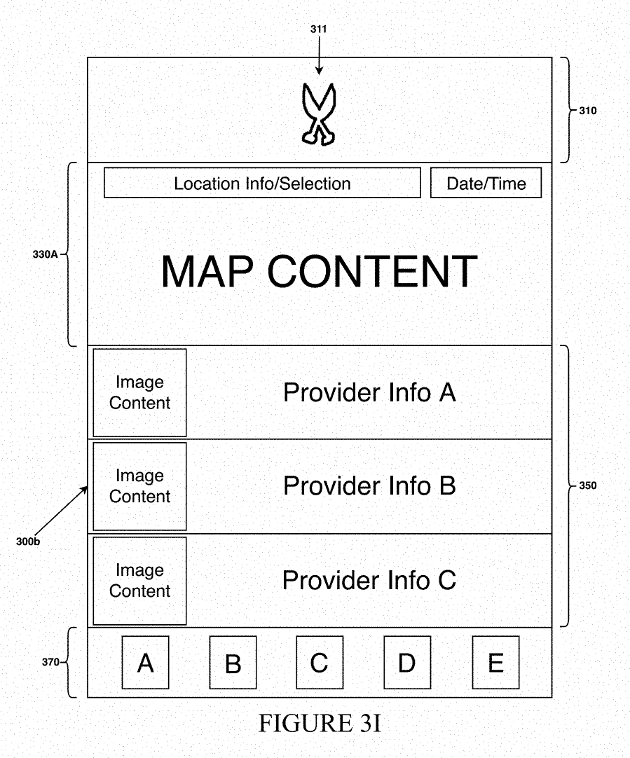

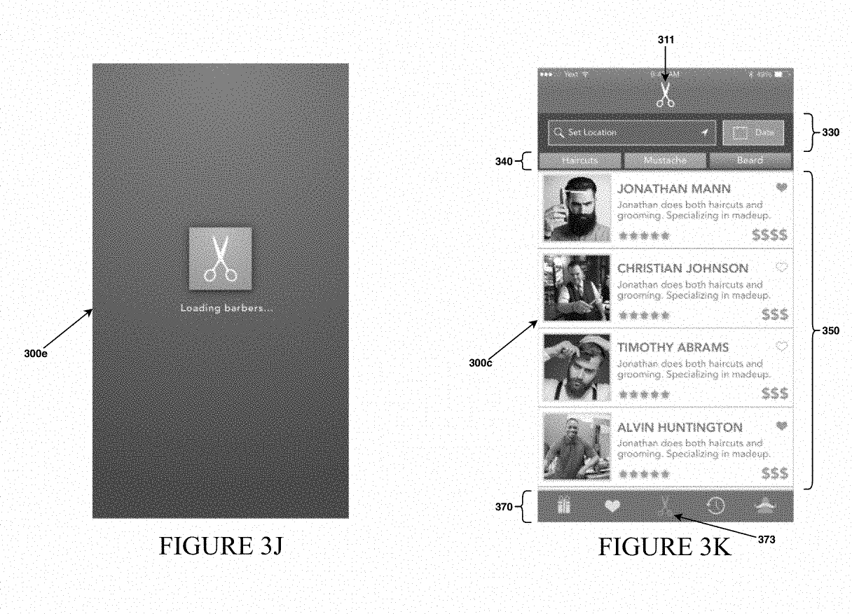

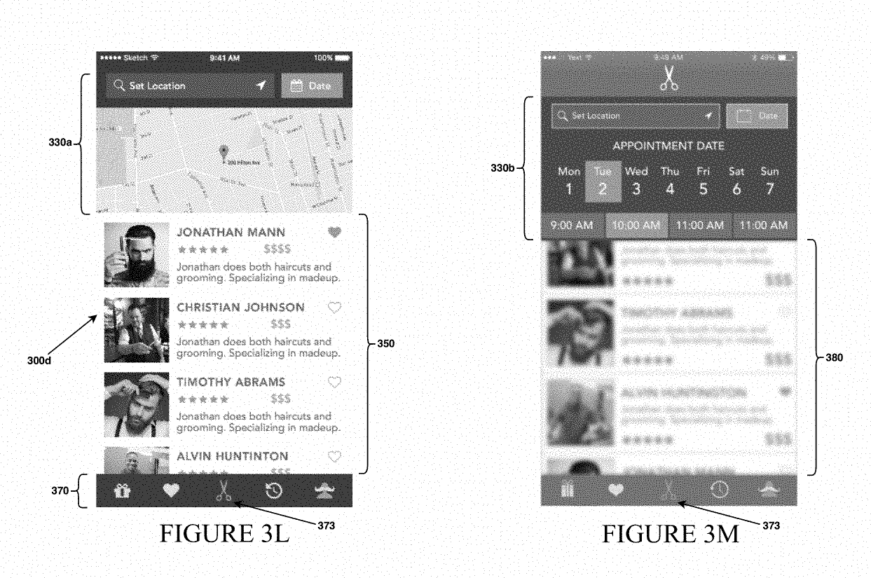

FIGS. 3A-3M illustrate examples of user interfaces that are displayed to a user to enable the user to request an on-demand user-based service, according to an embodiment. FIG. 3A illustrates an optional selection feature as described in FIGS. 1-2, FIG. 3B illustrates a multi-option selection feature as described in FIGS. 1-2, FIG. 3C illustrates a location info/selection feature as described in FIGS. 1-2, FIG. 3D illustrates a date/time selection feature as described in FIGS. 1-2, FIG. 3E illustrates a firsts set of selection features as described in FIGS. 1-2, FIG. 3F illustrates a user-based service provider selection feature as described in FIGS. 1-2, FIG. 3G illustrates a display page selection panel, FIG. 3H illustrates a first example of a summary panel (concurrently with the plurality of selection features of FIGS. 3A-3F) as described in FIGS. 1-2, and FIG. 3I illustrates a second example of a summary panel (concurrently with the plurality of selection features of FIGS. 3C, 3D, 3F, and 3G) as described in FIGS. 1-2. FIGS. 3H-3M illustrate a set of user interfaces that illustrate examples of user interfaces described in FIGS. 1-2. For example, the home page user interfaces 300a, 300b, 300c, and 300d of FIGS. 3H, 3I, 3K and 3L, respectively, the service type loading page 300e of FIG. 3J, an expanded date/time selection user interface 330b of FIG. 3M, and an expanded location info/selection user interface 330a of FIG. 3L, illustrate user interfaces that can be provided by a barber service application (e.g., which is an example of an on-demand user-based service application) running or being operated on a user's computing device (e.g., a smart phone).

When a user initiates and operates the on-demand user-based service application on his or her computing device, for example, a home page (default page) user interface can be provided to the user. The user can interact with features on the home page user interface in order to request a user-based service. In some implementations, the home page user interface can include a plurality of selection features including a multi-option selection feature 310, an optional selection feature 320, a location/date/time selection feature panel 330 with a location info/selection feature 331 and a date/time selection feature 332, a first set of selection option features 340, a user-based service provider selection feature 350, and a display page selection panel 370, as illustrated in FIG. 3H, or any combination thereof. For example, all of the plurality of selection features can be included in the home page (default page) user interface (as shown in the home page user interface 300a of FIG. 3H). In another example, the multi-option selection feature is defaulted to a barbering service application and only the location/date/time selection feature panel 330 with the location info/selection feature 331 and the date/time selection feature 332, the first set of selection option features 340, the user-based service provider selection feature 350, and the display page selection panel 370 are included (as shown in the home page user interface 300c of FIG. 3K). In yet another example, the multi-option selection feature is defaulted to a barbering service application and only the location/date/time selection feature panel 330 (including the map content 333, as depicted in FIG. 3C) with the location info/selection feature 331 and the date/time selection feature 332, the user-based service provider selection feature 350, and the display page selection panel 370 are included (as shown in the home page user interfaces 300b and 300d of FIGS. 3I and 3L).

The multi-option selection feature 310 (as depicted individually in FIG. 3B) can include a plurality of service type selection icons 311, 312, 313, 314, and 315 that can be individually selected by the user (via an input mechanism) to be enlarged to indicate which one of the selection icons is currently selected. Each of the selection icons of the multi-option selection feature can correspond to a particular service type that the user can select to request a specific on-demand user-based service. The available service types can be identified with the specific depiction of the selection icons, for example pictographs of the service type represented by the selection icon. The first selection icon 311 depicts a pictograph of a hair stylist, for example, a blow dryer, the second selection icon 312 depicts a pictograph of a masseuse, for example, two human hands, the third selection icon 313 depicts a pictograph of a barber, for example, scissors, the fourth selection icon 314 depicts a pictograph of a esthetician, a human face with a steam towel thereon, and the fifth selection icon 315 depicts a pictograph of a makeup artist, for example, a human face with blush and eye makeup thereon. The plurality of service type selection icons 311, 312, 313, 314, and 315 can depict any recognizable pictograph of the specific service type that the icons represent.

In some cases, based on the user's region, different user-based service types can be provided with the multi-option selection feature 310. For example, the user-based service types can include barbers, estheticians, masseuses, nail salon artists, makeup artists and hair stylists. The multi-option selection feature 310 can be presented on the display to include only user-based service types that are available so that the user-based service types that are unavailable in that locale are not displayed or are displayed in a different fashion to be distinguishable to the user (e.g., a different color, shading, text type, etc.). In another example, the multi-option selection feature 310 can prevent the user from making a selection of a specific service type selection icon that is unavailable if the user attempts to select the unavailable service type selection icon. In one embodiment, the selection of one of the plurality of service type selection icons by the user (via an input mechanism) briefly presents the service type loading page of FIG. 3J (if switching between service types) and then the corresponding service type home page (default page) user interface is provided to the user (as depicted in FIG. 3H). In other embodiments, the multi-option selection feature is defaulted to a single user-based service type and no other options are presented, as shown in FIGS. 3I, 3K and 3L, only the barber icon 313 is displayed and the user is unable to select any of the other service type selection icons.

The optional selection feature 320 (as depicted individually in FIG. 3A) can include a track 321 and a slider feature 322 that can be manipulated by the user (via an input mechanism) to be moved along the track 321. Each resting point or “stop” on the track can correspond to a particular service option that the user can select when requesting an on-demand user-based service. The available service options can be identified with an identifier 325.

In some cases, based on the user's region, different service options can be provided with the optional selection feature 320. For example, the user-based service options associated with the optional selection feature 320, can be presented on the display to include only user-based service options that are available in the user's region. The optional selection feature 320 can be presented on the display to include only user-based service options that are available so that options that are unavailable in that locale are not displayed or are displayed in a different fashion to be distinguishable to the user (e.g., a different color, a different shade, a different text type, etc.). In another example, the optional selection feature 320 can prevent the user from making a selection of a user-based service option that is unavailable if the user attempts to select a stop that corresponds to an unavailable service option. Once the user makes a selection, the home page user interface is dynamically updated/refreshed to display only user-based service providers, for example, barbers that meet the criteria of the optional selection feature that is chosen. In one implementation, the optional selection feature 320 allows the user to choose the profession level of the barber, or other user-based service provider as previously listed, which can be defaulted to the selection or stop representing expert, and then the home page user interface is dynamically refreshed to display only barbers, or user-based providers, of that specific profession level in the user's region within the panel containing the user-based service provider selection feature 350 (as seen in FIG. 3F).

The location/date/time selection feature 330 (as depicted individually in FIGS. 3C and 3D) can include a location info/selection option feature 331 and a date/time selection feature 332 (e.g., selection/input buttons or tiles or boxes as shown in home page user interfaces 300a and 300b of FIGS. 3H and 3I, respectively) that can be selected individually by a user (via an input mechanism) to display a specific drop down selection panel feature for each of the selection option features 331 or 332. For example, upon the user's selection of the location info/selection option feature 331 the drop down location info/selection panel feature 330a containing the location info/selection options (as depicted in FIG. 3C) is displayed/presented to the user in addition to the selection box allowing the user to input (via a keyboard popup) a particular on-site user-based service location for the user to receive the user-based services, e.g. the user's home or work address, or a friends address, which is then checked and/or verified by the map database for accuracy (location suggestions are displayed directly below the text input box and are selectable via the user tapping or pressing on the desired suggested location). The drop down location info/selection panel feature 330a also includes the map content 333, e.g. a map defaulted to display the user's location and/or the user's inputted map checked on-site location, and the surroundings thereof i.e. streets, stores, points of interest, etc. The drop down location info/selection panel feature 330a also includes a cancel selection box 336 that deselects the drop down location info/selection panel feature 330a (pops it back up), and the home page user interface is once again displayed/presented to the user. Alternatively, upon the user's selection (via an input mechanism) of an area outside of the drop down location info/selection panel feature 330a, the drop down location info/selection panel feature 330a is deselected (popped back up), and the home page user interface is once again displayed/presented to the user. For example, upon the user's selection of the date/time selection feature 332 the drop down date/time selection panel feature 330b containing the date/time selection options (as depicted in FIGS. 3D and 3M) is displayed/presented to the user (the home page user interface directly below the drop down date/time selection panel feature 330b is blurred as represented as numerical 380 of FIG. 3M). The drop down date/time selection panel feature 330b includes the location info/selection option feature 331 (e.g., selection box) which when selected displays/presents the drop down location info/selection panel feature 330a, as described above. The drop down date/time selection panel feature 330b also includes a calendar date selection feature 334, which can include a plurality of date selection tiles/boxes, each of the plurality of date selection tiles/boxes corresponds to a specific day of the week and displays the abbreviation for the specific day of the week above the numerical date. The calendar date selection feature 334 further allows the user to slide or side-scroll through the ordered date selection tiles/boxes (e.g., the user drags one of the date selection tiles/boxes to the left or right to display dates further into the future or closer into the future) in order to choose the specific date that the user requires rendering of the barber services. Upon selection (via an input mechanism) of one of the plurality of date selection tiles/boxes, the selected date selection tile/box is highlighted (darkened, lightened, etc.) to indicate that it has been selected. The drop down date/time selection panel feature 330b also includes a time selection feature 335, which can include a plurality of time selection tiles/boxes, each of the plurality of time selection tiles/boxes depicts a specific time within the barber service providers schedule, the plurality of time selection tiles/boxes can be incremented in specific time periods (e.g., the first time selection box depicts “11:30”, and the second time selection box depicts “12:00”, etc.) including 15 minute increments, 30 minute increments, etc. The time selection feature 335 further allows the user to slide or side-scroll through the ordered time selection tiles/boxes (e.g., the user drags one of the time selection tiles/boxes to the left or right to display times further into the future or closer into the future) in order to choose the specific time that the user requires rendering of the barber services. Upon selection (via an input mechanism) of one of the plurality of time selection tiles/boxes, the selected time selection tile/box is highlighted (darkened, lightened, etc.) to indicate that it has been selected. The drop down date/time selection panel feature 330b also includes the date/time selection feature 332 that, once selected again by the user (via an input mechanism), deselects the drop down date/time selection panel feature 330b (pops it back up), and the home page user interface is once again displayed/presented to the user. Alternatively, upon the user's selection (via an input mechanism) of an area outside of the drop down date/time selection panel feature 330b, the drop down date/time selection panel feature 330b is deselected (popped back up), and the home page user interface is once again displayed/presented to the user.

In some cases, the location/date/time selection feature 330 is defaulted to the user's current location (or the user's pre-set default location), the current date and the closest future increment of time available to receive the on-demand user-based services. For example, the date/time selection feature 332 can be defaulted to the current date and the current time, i.e. on-demand. In the case that the user chooses to select a future date and time by selecting the date/time selection feature 332 (via an input mechanism), the drop down date/time selection panel feature 330b is presented/displayed to the user with the date selection feature 334 defaulted to the date selection tile/box corresponding to current day with a plurality of date selection tiles/boxes corresponding to the following days (e.g., the current day is Monday July 22, the left most date selection tile/box displays Monday above the number 22 and the plurality of selection tiles/boxes to the right display: Tuesday above the number 23, Wednesday above the number 24, etc.). The time selection feature 335 presented within the drop down date/time selection panel feature 330b to the user is defaulted to the next increment of time beyond the current time with a plurality of time selection tiles/boxes corresponding to the following time increments (e.g., the current time is 11:01 AM, the left most time selection tile/box displays 11:30 AM and the plurality of time selection tiles/boxes to the right display: 12:00 PM, 12:30 PM, 1:00 PM, etc.). Upon the user's selection (via an input mechanism) of a on-site user-based service location and/or a date/time and the drop down location info/selection panel feature 330a and the drop down date/time selection panel feature 330b are deselected, the home page user interface is updated to display/present to the user only user-based service providers, i.e. barbers, that are available to render the user services for the selected location at the date and time selected by the user (further described below).

The first set of selection option features 340 (as depicted individually in FIG. 3E) can include a plurality of service option selection boxes 341, 342, 343, and 344 (the plurality of service option selection boxes may include less than or more than four service option selection boxes, including one, two, three, five, six, seven, eight, nine, or ten s service option selection boxes, depending on the number of user-based services available to select from), each one the plurality of service option selection boxes can be individually selected by a user (via an input mechanism) to select at least one specific service option to be provided to the user by the user-based service provider (e.g., a first service, a second service, a third service and a fourth service, etc.). Upon selection (via an input mechanism) of one of the plurality of service option selection boxes, the selected service option selection box(es) is/are highlighted (darkened, lightened, etc.) or otherwise indicates selection, or by placing a check within the service option selection boxes that are selected to indicate that it has been selected.

In some cases, based on the user's region, different service options can be provided with the first set of selection option features 340. For example, the service options associated with the first set of selection option features 340, can be presented on the display to include only specific service options that are available in the user's region. The first set of selection option features 340 can be presented on the display to include only service options that are available so that selection options that are unavailable in that locale are not displayed or are displayed in a different fashion to be distinguishable to the user (e.g., a different color, a different shade, a different text type, etc.). In another example, the first set of selection option features 340 can prevent the user from making a selection of a service option that is unavailable if the user attempts to select a service option selection box that corresponds to an unavailable service option. Once the user makes a selection, the home page user interface is dynamically updated/refreshed to display only user-based service providers, for example barbers that meet the criteria of the one of or more of the plurality of service options that is/are chosen. In one implementation, the first set of selection option features 340 allows the user to at least one of a plurality of services to be rendered by the barber, or other user-based service provider as previously listed, which can be defaulted to the service option selection box representing haircut, and then the home page user interface is dynamically updated/refreshed to display only barbers, or user-based providers, that are capable of performing the selected one of or more of the plurality of service options in the user's region within the panel containing the user-based service provider selection feature 350 (as seen in FIG. 3F).

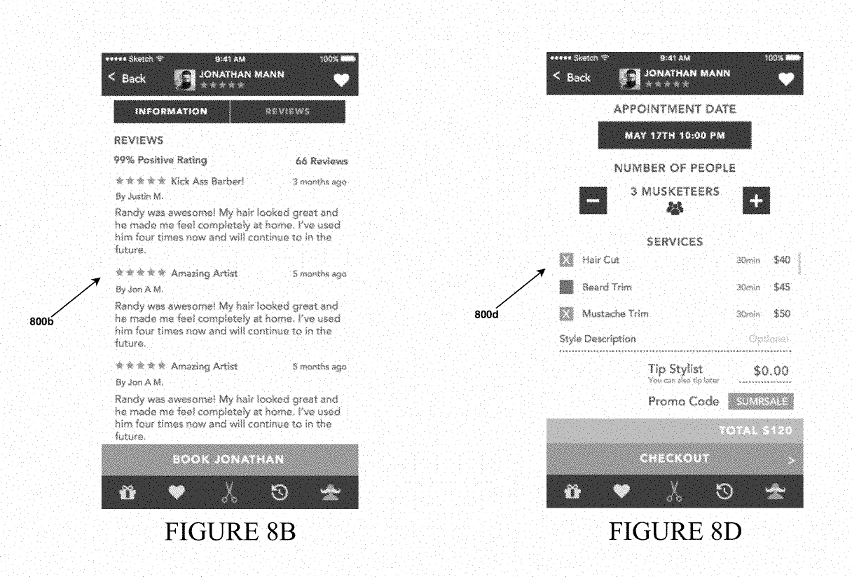

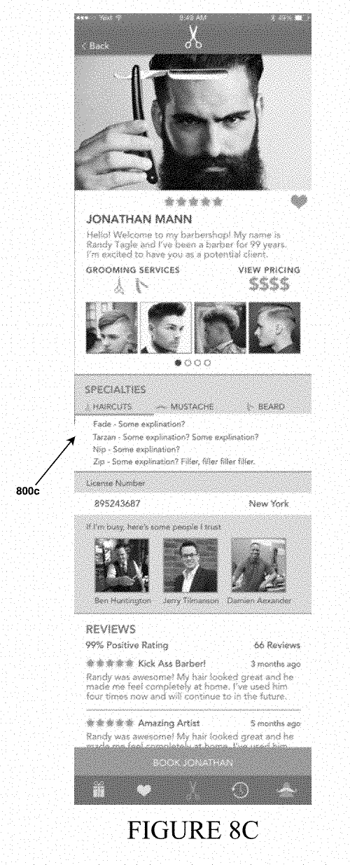

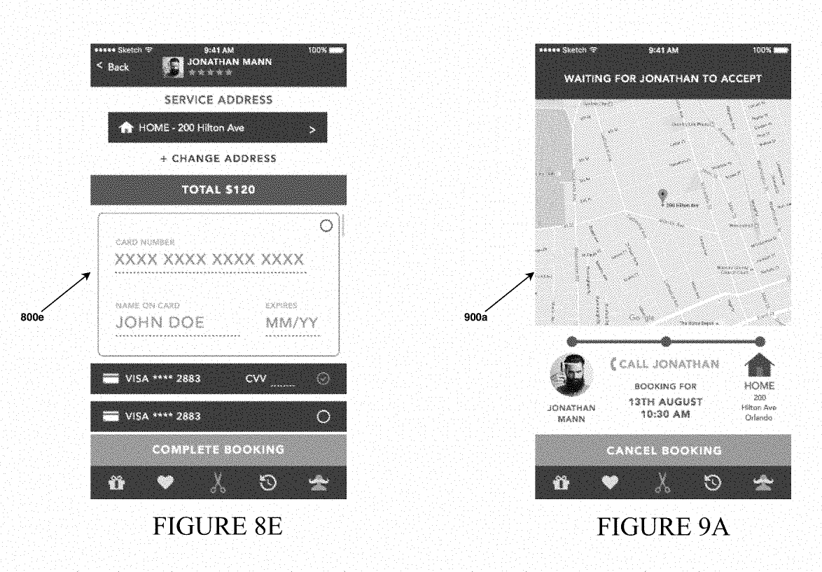

The user-based service provider selection feature 350 (as depicted individually in FIG. 3F) can include a plurality of individual service provider selection panels 356, 357, and 358 (the plurality of individual service provider selection panels may include less than or more than three individual service provider selection panels visible to the user at one time, including one, two, four, five, six, seven, eight, nine, or ten, etc.) listed in a scrollable manner (e.g., the user can drag up and down on the screen, via a user input mechanism, to view different pluralities of individual service provider selection panels), each one of the plurality of individual service provider selection panels displays provider info for a specific user-based service provider and can be individually selected by a user (via an input mechanism). Upon the user's selection of one of the individual service provider selection panels 356, 357, and 358 the corresponding individual service provider interface 800a, 800b (as depicted in FIGS. 8A and 8B and further define below), or alternatively the service provider virtual shop interface 800c, is displayed/presented to the user (as depicted in FIG. 8C and further defined below). Provided within the plurality of individual service provider selection panels 356, 357, and 358 is a profile/cover photo 351, 352, and 353, respectively, of the particular user-based service provider, and provider info which can include: a name of the particular user-based service provider; a favorites indicator (e.g., a heart icon that is filled to indicate that the particular user-based service provider is a favorite, and is unfilled/uncolored to indicate that the particular user-based service provider is not a favorite); a rating/review score of the particular user-based service provider; and a brief description of the particular user-based service provider (e.g., Jonathan does both haircuts and grooming, specializing in moustache trims and beard trips, etc.).

In some cases, based on the user's selection of the plurality of selection features (e.g., the optional selection feature 320, the location/date/time selection feature panel 330 with a location info/selection feature 331 and a date/time selection feature 332, and the first set of selection option features 340), or the default selections, the user-based service provider selection feature 350 with the plurality of individual service provider selection panels 356, 357, and 358 is dynamically updated/refreshed to display only the corresponding plurality of individual service provider selection panels corresponding to the specific service providers meeting the criteria of the user's selection of the plurality of selection features or default selections (e.g., upon a user's selection of a specific date/time, and specific user-based services to be rendered, only user-based service providers that are available at the selected time/date and capable of performing the selected user-based services to be rendered are displayed). For example, in the on demand barbering service, only the individual service provider selection panels corresponding to the barbers that can perform haircuts on the current date (e.g. August 12^{th}), i.e. default selections, are displayed within the user-based service provider selection feature 350 in a scrollable and selectable manner.

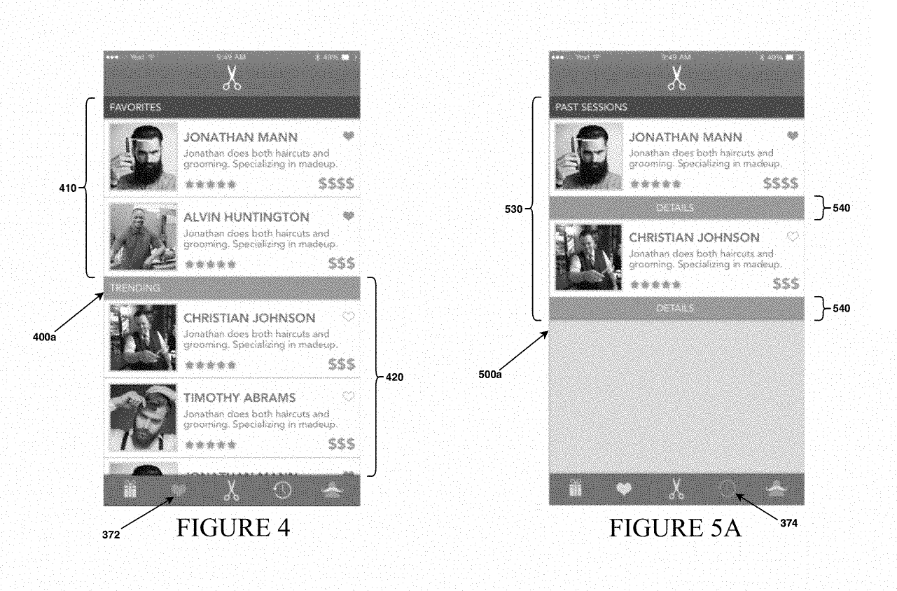

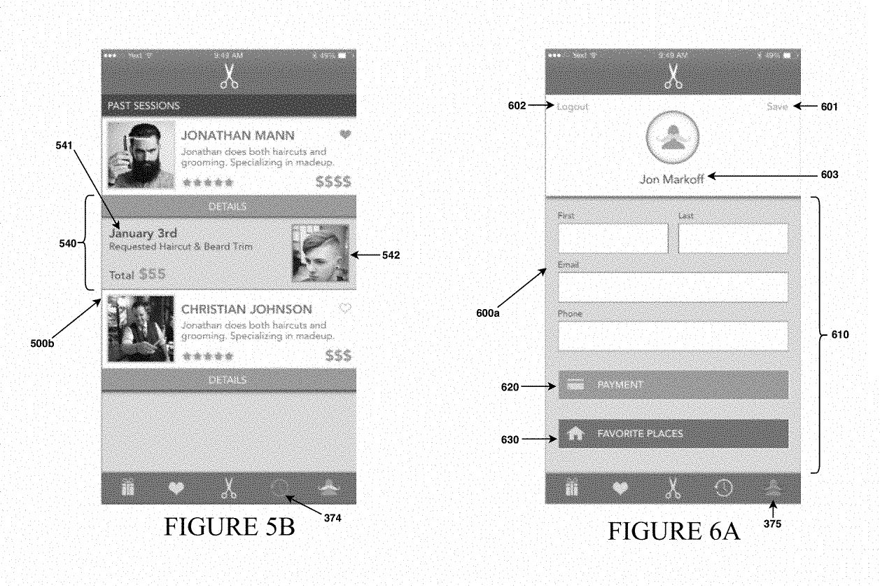

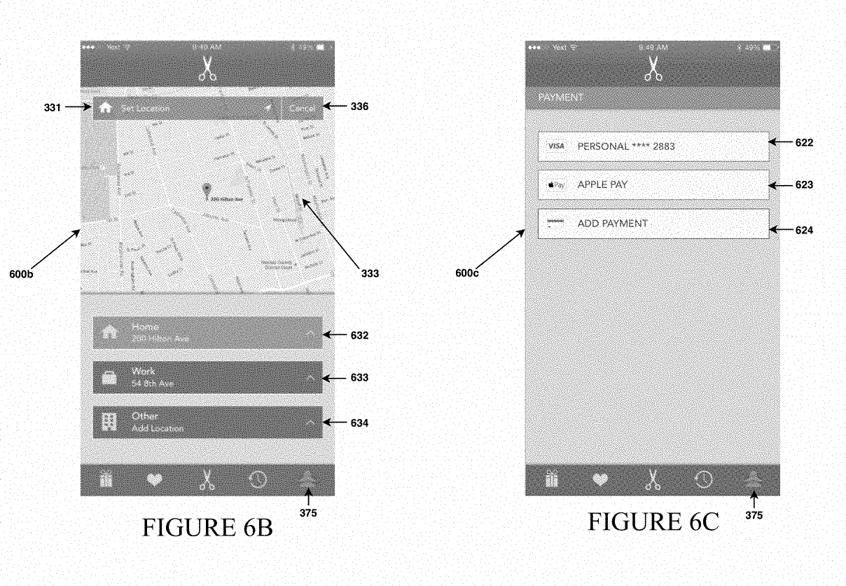

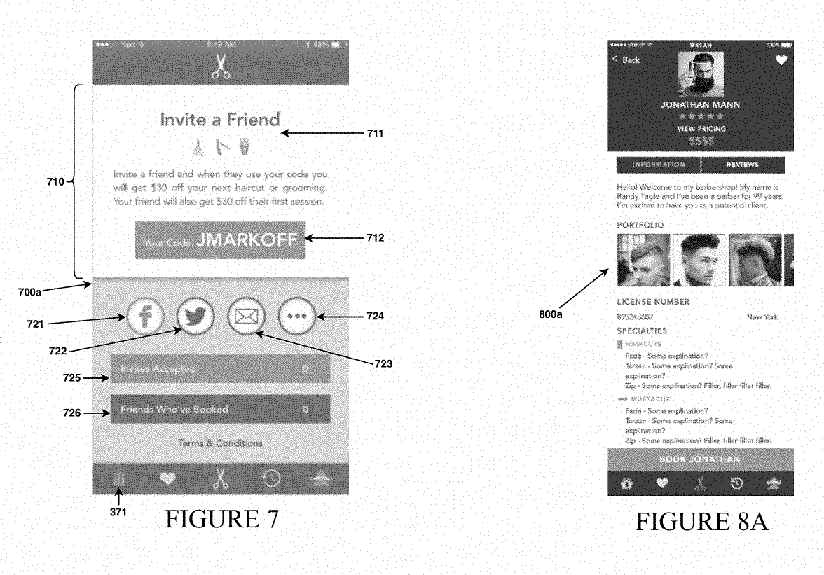

The display page selection panel 370 (as depicted individually in FIG. 3G) can include a plurality of display page selection icons 371, 372, 373, 374, and 375 (the plurality of display page selection icons may include less than or more than five display page selection icons, including one, two, three, four, six, seven, eight, etc.), that can be individually selected by the user (via an input mechanism) to display/provide a corresponding interface including: a gifts and referrals user interface 700a (as depicted in FIG. 7 and further described below); a favorites and trending user interface 400a (as depicted in FIG. 4 and further described below); the home page user interfaces 300a, 300b, 300c, and 300d (as depicted in FIGS. 3H, 3I, 3K and 3L); a past sessions user interface 500a (as depicted in FIGS. 5A and 5B and further described below); and a user profile user interface 600a (as depicted in FIG. 6A and further described below) which includes a favorite on-site locations/places user interface 600b (as depicted in FIG. 6B and further described below) and a payment user interface 600c (as depicted in FIG. 6C and described below) to the user. The user interfaces that the display page selection icons correspond to can be identified with the specific depiction of the selection icons, for example pictographs of the user interface represented by the selection icon. The first display page selection icon 371 depicts a pictograph of a gift, for example, a gift box with a bow, the second display page selection icon 372 depicts a pictograph of a favorite, for example, a heart, the third display page selection icon 373 depicts a pictograph of a barber (or other user-based service icon including any of the plurality of service type selection icons 311, 312, 313, 314, and 315, as previously described above), for example, scissors, the fourth selection icon 374 depicts a pictograph of the past, for example, a clock with the outer circumference including an arrow in the counter-clockwise direction, and the fifth selection icon 375 depicts a pictograph of a person, for example, a silhouette of a human head having a large moustache thereon. The plurality of display page selection icons 371, 372, 373, 374, and 375 can depict any recognizable pictograph of the specific user interface that the icons represent.

FIG. 4 illustrates an example of the favorites and trending user interface that is displayed to a user when the user selects the corresponding display page selection icon (via an input mechanism) within the display page selection panel. For example, the favorites and trending user interface 400a of FIG. 4 can illustrate a user interface that is provided by a barber service application in response to the user selecting the third display page selection icon 373, which depicts a pictograph of a favorite (as described above). The favorites and trending user interface 400a can include the scrollable user-based service provider selection feature 350 (as described above), that includes only individual service provider selection panels of corresponding service providers that have been selected as favorites by the user (e.g., favorites user-based service provider selection feature 410). The favorites and trending user interface 400a can also include a separate scrollable user-based service provider selection feature 350 (as described above), that includes only individual service provider selection panels of corresponding service providers that have been indicated as trending (via the user-based service application) by the user (e.g., trending user-based service provider selection feature 420). Each of the favorites user-based service provider selection feature 410 and the trending user-based service provider selection feature 420 include all of the display information and selection features of the user-based service provider selection feature 350 (as described above). In some cases, the favorites user-based service provider selection feature 410 and/or the trending user-based service provider selection feature 420 will be empty or blank, for example when the user has yet to select any favorite user-based service providers the favorites user-based service provider selection feature 410 will list no individual service provider selection panels, or when eh user-based service application has yet to determine what is trending the trending user-based service provider selection feature 420 will list no individual service provider selection panels.

FIGS. 5A and 5B illustrate examples of the past sessions user interfaces that are displayed when the user selects the corresponding display page selection icon (via an input mechanism) within the display page selection panel. For example, the past sessions user interface 500a of FIG. 5A can illustrate a user interface that is provided by a barber service application in response to the user selecting the fourth display page selection icon 374, which depicts a pictograph of the past (as described above). The past sessions user interface 500a of FIG. 5A can include the scrollable user-based service provider selection feature 350 (as described above), that includes only individual service provider selection panels of corresponding service providers that have been previously utilized by the user listed in order of most recent to least recent from top to bottom (e.g., past sessions user-based service provider selection feature 530). The past sessions user-based service provider selection feature 530 includes all of the display information and selection features of the user-based service provider selection feature 350 (as described above), as well as including a past sessions details drop down selection panel feature 540. The past sessions details drop down selection panel feature 540 is displayed below each of individual service provider selection panels of the corresponding service providers (as shown in FIG. 5A) and displays the term “DETAILS” or similar terminology when un-selected. Upon selection of one of the corresponding past sessions details drop down selection panel feature 540 by a user (via an input mechanism), the past sessions details drop down selection panel feature 540 is expanded and displayed/presented to the user as illustrated in the past sessions user interface 500b of FIG. 5B. The expanded past sessions details drop down selection panel feature 540 can include past session information 541 including: the date of the past session (in month day format); the total cost of the past session; the services rendered in the past session; etc., the expanded past sessions details drop down selection panel feature 540 can also include a past session image/photograph 542 that is taken by the user-based service provider or the user and depicting a final picture of the user-based services received by the user and conducted by the particular user-based service provider. For example, the past sessions user interface 500b of FIG. 5B can illustrate a user interface that is provided by a barber service application in response to the user selecting one of the past sessions details drop down selection panel features 240, corresponding to the barber below which it is displayed (as previously described), the expanded past sessions details drop down selection panel feature 540 with the past session information 541 and the past session image/photograph 542 is presented or displayed to the user. the expanded past sessions details drop down selection panel feature 540 with the past session information 541 and the past session image/photograph 542 can allow the user to refresh his/her memory of their past experience with the particular barber, or other user-based service provider, in one of their past sessions.

FIGS. 6A, 6B and 6C illustrate examples of the user profile user interfaces that are displayed when the user selects the corresponding display page selection icon (via an input mechanism) within the display page selection panel. For example, the user profile user interface 600a of FIG. 6A can illustrate a user interface that is provided by a barber service application in response to the user selecting the fifth display page selection icon 375, which depicts a pictograph of a person (as described above). The user profile user interface 600a can include a signup page that may include options to sign-up manually or to import personal information and utilize an existing authorization token to sign-up/sign-in (e.g., Facebook™ Google™, etc.). In the case that the user selects the option to sign up manually, the user will be asked for their personal information such as: email, phone number, first name, last name, etc. as well as be asked to create a password for security. In the case that the user selects the option to utilized an existing authorization token to sign-up/sign-in, the user will be presented with username and password input fields for the corresponding method (e.g., email address and password, etc.). The user profile user interface 600a of FIG. 6A can include text selection buttons 601 and 602, which can allow the user to save entered information, payment methods and favorite places (text selection button 601), or to logout of their user profile (text selection button 602). The user profile user interface 600a can also display the user's profile name 603 to enable a user to know which user profile is currently logged in. The user profile user interface 600a of FIG. 6A can include a profile information selection feature panel 610 that may include the personal information input fields, a saved payments selection feature 620 (e.g., selection button or tile), and a favorite places/on-site locations selection feature 630 (e.g., selection button or tile). Upon selection of the favorite places/on-site locations selection feature 630 by a user (via an input mechanism) the user is presented with a user profile favorite places/on-site locations user interface 600b.

The user profile favorite places/on-site locations user interface 600b of FIG. 6B can include the location info/selection panel feature 330a with the location info/selection option feature 331, the map content 333, and the cancel selection box 336 (as described above) which returns the user to the user profile user interface 600a at a top portion thereof. The location info/selection panel feature 330a allows the user to input, select and save (via an input mechanism) the locations of their home, work and other on-site user-based service locations that the user does not want to repetitively enter into the barber service application, or other user-based service application. The user profile favorite places/on-site locations user interface 600b can also include a plurality of favorite location selection buttons including a first favorite location selection button 632, a second favorite location selection button 633, and a third favorite location selection button 634 (the plurality of favorite location selection buttons may include less than or more than three favorite location selection buttons, including one, two, four, five, six, seven, eight, etc.). The first favorite location selection button 632 can represent the user's saved home on-site user-base service location, the second favorite location selection button 633 can represent the user's saved work on-site user-based location, and the third favorite location selection button 634 can represent other saved on-site user-based locations (e.g., an alternative home or worksite, a frequent friend's home, etc.). Upon selection of one of the plurality of favorite location selection buttons by a user (via an input mechanism), the user can modify/select either an on-site location to save initially or an on-site location to modify/change to a different on-site location thereby enabling a user to save desired and frequent on-site user-based locations at which the user intends to receive user-based services. Upon selection of the saved payments selection feature 620 by a user (via an input mechanism) the user is presented with a user profile saved payments user interface 600c.

The user profile saved payments user interface 600c of FIG. 6C can include a plurality of saved payment selection boxes/tiles 622, 623, 624 (the plurality of saved payment selection boxes/tiles may include less than or more than three saved payment selection boxes/tiles, including one, two, four, five, six, seven, eight, etc.). The first saved payment selection box/tile 622 displays the user's first saved payment method (e.g., Visa™ followed by the term “Personal” and the last four digits of the user's credit card, etc.), the second saved payment selection box/tile 623 displays the user's Apple Pay™ payment option (or Android Pay™ payment option), and the third or last saved payment selection box/tile 624 displays the text “Add Payment” and allows the user to add a new payment method (e.g., credit card, Paypal™, etc.) to be saved as a new saved payment selection box/tile. In one example, before the user has saved any payment methods within the user profile saved payments user interface 600c only the second and third saved payment selection boxes/tiles 623 and 624 displaying the user's Apple Pay™ payment option and the text “Add Payment” and allows the user to add a new payment method, upon addition of new payment methods by the user, each new saved payment method will be displayed via one of the plurality of saved payment selection boxes/tiles. Once at least one of the plurality of payment methods is saved as a saved payment selection box/tile it can be selected by the user (via an input mechanism) and edited, deleted, updated, or chosen as their default payment method.

FIG. 7 illustrates an example of a gifts and referrals user interface that is displayed to a user when the user selects the corresponding display page selection icon (via an input mechanism) within the display page selection panel. For example, the gifts and referrals user interface 700a of FIG. 7 can illustrate a user interface that is provided by a barber service application in response to the user selecting the first display page selection icon 371, which depicts a pictograph of a gift (as described above). The gifts and referrals user interface 700a can include an invite a friend display feature 710 with a description of the details of the user inviting friends and family and the current updated offer detail summary 711 as well as a user specific referral code 712 that the user informs their friends and family to enter upon initiation of their own user profile account. The gifts and referrals user interface 700a can also include a plurality of referral communication selection buttons 721, 722, 723, 724 (the plurality of referral communication selection buttons may include less than or more than four referral communication selection buttons, including one, two, three, five, six, seven, eight, etc.). The first referral communication selection button 721 may be a button that allows the user to share the barber application with the user's Facebook™ account, including their friends. The second referral communications selection button 722 may be a button that allows the user to share the barber application with the user's Twitter™ account, including their friends. The third referral communications selection button 723 may be a button that links to the user's email account to send their friends an invitation email. The fourth referral communications selection button 724 can be a button that provides a pop out or pop-up menu that provides additional means for a user to share the barber application with friends, such as an SMS text, etc. The gifts and referrals user interface 700a can also include a list of counters including: an “Invites Accepted” counter, and “Booked Friends” counter, each of the counters adds an additional number for each of the user's friends whom accept and book a barber, respectively.

FIGS. 8A-8E illustrate examples of the individual service provider interface, the user-based service provider virtual shop user interface, booking user interface and confirmation user interface that are displayed when the user first selects an individual service provider selection panel (via an input mechanism) within the user-based service provider selection feature 350. For example, the individual service provider user interface 800a of FIG. 8A can illustrate a user interface that is provided by a barber service application in response to the user selecting the corresponding individual service provider selection panel (e.g., from the home page user interface 300a, 300b, 300c, or 300d, the favorites and trending user interface 400a, or the past sessions user interface 500a). The individual service provider user interface 800a can include the provider info of the specific user-based service provider including: a name of the particular user-based service provider; a favorites indicator (e.g., a heart icon that is filled to indicate that the particular user-based service provider is a favorite, and is unfilled/uncolored to indicate that the particular user-based service provider is not a favorite); a rating/review score of the particular user-based service provider; and a brief description of the particular user-based service provider (e.g., Jonathan does both haircuts and grooming, specializing in moustache trims and beard trips, etc.), as previously described, and further include more detailed information regarding the specific user-based service provider including: a cost category indicator (e.g., between one and 4 money signs indicating the level of cost of the user-based service provider's services); the individual service provider's Instagram™ or photo gallery (e.g., displaying the user-based service providers work portfolio); the individual user-based service provider's professional license number and licensed state; and the individual user-based service provider's specialties and specific cost information. The individual service provider user interface can include an information tab (as depicted in the individual service provider user interface 800a of FIG. 8A) and a reviews tab (as depicted in the individual service provider user interface 800b of FIG. 8B). In another example, the user-based service provider virtual shop user interface 800c of FIG. 8C can illustrate a similar user interface that is provided by a barber service application in response to the user selecting the corresponding individual service provider selection panel (e.g., from the home page user interface 300a, 300b, 300c, or 300d, the favorites and trending user interface 400a, or the past sessions user interface 500a). The user-based service provider virtual shop user interface 800c can include all of the information of the individual service provider user interface 800a, displayed in a different manner (e.g., as shown in FIG. 8C). Each of the individual service provider user interface 800b and the user-based service provider virtual shop user interface 800c can include a booking request feature (e.g., a button with the text “book” followed by the individual service provider's name), which upon selection of the booking request feature by the user (via an input mechanism), the user-based service application provides a booking user interface 800d to the user.

For example, the booking user interface 800d of FIG. 8D can illustrate a user interface that is provided by a barber service application in response to the user selecting the booking request feature (e.g., from the individual service provider user interface 800b or the user-based service provider virtual shop user interface 800c of FIGS. 8A-8C). The booking user interface 800d can include at least one of the plurality of selection features, specifically the optional selection feature 320 (for selecting the number of users to receive services, e.g., by an individual optional selection feature, or via the first set of selection option features), the date/time selection feature 332 (selectable through an appointment date/time selection feature 830), the first set of selection option features 340, and the display page selection panel 370. The booking user interface 800d can also include a tipping feature that allows the user to enter an amount to tip the selected individual user-based service provider, and a promotional code feature that allows the user to enter special promotional codes. The booking user interface 800d can also include a continue booking request feature (e.g., a button having the text “continue booking” or “checkout”, etc.), which upon selection of the continue booking request feature by the user (via an input mechanism), the user-based service application provides a confirmation user interface 800e to the user.

For example, the confirmation user interface 800e of FIG. 8E can illustrate a user interface that is provided by a barber service application in response to the user selecting the continue booking request feature (e.g., from the booking user interface 800d of FIG. 8D). The confirmation user interface 800e can include service-specific information about the selected individual user-based service provider and the selected user-based service options associated with the selected icons, states, boxes, or tiles with which the service request feature of the selection is provided, the service-specific information including at least one of the current location or user-selected location of the computing device, cost information, account information of the user used to pay for the user-based on-demand service, or information about a user-based service provider that is providing the user-based service option associated with the selected icons, states, boxes, or tiles. The confirmation user interface 800e can also include an address selection feature to enable the user to select one of the saved on-site user-based service locations or add a new address, or utilize the current location of the computing device, the total cost of services and a payment selection method to enable the user to select one of the saved payment methods, or add a new payment method (as described previously). The confirmation user interface 800e can also include a complete booking service request feature (e.g., a button with the text “Complete Booking” or “Confirm Booking”, etc.), which upon selection of the continue booking service request feature by the user (via an input mechanism), the user-based service application provides an appointment/booking status user interface 900a to the user.

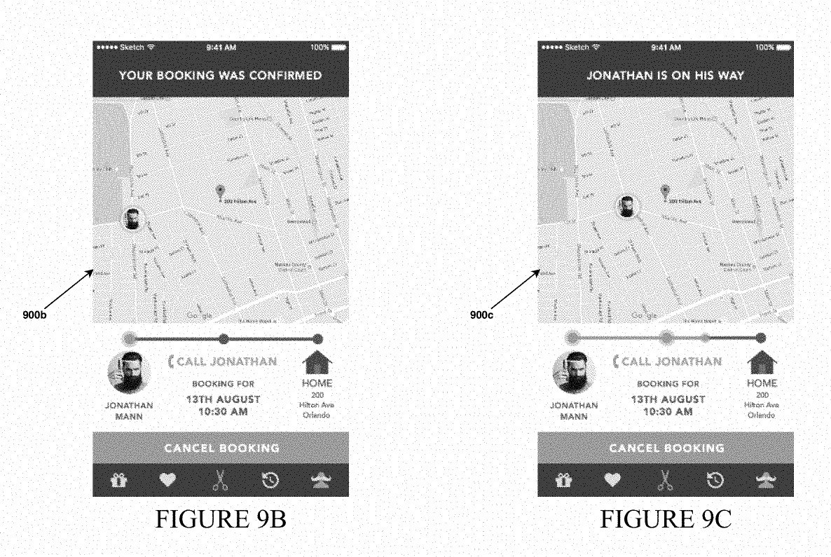

FIGS. 9A-9C illustrate examples of appointment/booking status user interfaces that are displayed when the user selects the continue booking service request feature (via an input mechanism) within the confirmation user interface. For example, the appointment/booking status user interface 900a of FIG. 9A can illustrate a user interface that is provided by a barber service application in response to the user selecting the complete booking service request feature (e.g., from the confirmation user interface 800e of FIG. 8E). The appointment/booking status user interface 900a can include a map content depicting the user's current location, or user-selected location at which the user-based services are to be rendered, including surrounding streets and geographical information. The appointment/booking status user interface 900a can also include the status of the appointment according to the selected individual user-based service provider, such as the text “waiting for” followed by the individual user-based service providers name, followed by “to accept”, in addition to a graphic depicting a the profile photo/image of the individual service provider, a call service provider selection feature, and the on-site user-based service location (e.g., a pictograph of a house with the user's current or selected address for the appointment below it), above which a sliding track feature with stops depicting the status of the appointment and the location of the individual user-based service provider. The appointment/booking status user interface 900a can also include a cancel booking request feature that allows the user to cancel the appointment/booking with the selected individual user-based service provider. Upon acceptance of the user's requested appointment/booking by the selected individual user-based service provider, the appointment/booking status user interface 900b is displayed to the user. The appointment/booking status user interface 900b can include all of the features and content displayed on the appointment/booking status user interface 900a, with the exception of the status at the top being updated to display the text “Your Booking Was Confirmed” and the left/first stop of the sliding track feature of the graphic is selected and highlighted to indicate the confirmation by the individual user-based service provider. Once the individual user-based service provider initiates travel to the selected on-site service location, the appointment/booking status user interface 900c is displayed to the user. The appointment/booking status user interface 900c can include all of the features and content displayed on the appointment/booking status user interfaces 900a and 900b, with the exception of the status at the top being updated to display the individual service provider's name followed by the text “is on his/her way” and the sliding track is filled from the left/first stop to the center/second stop and the center/second stop of the sliding track feature of the graphic is selected and highlighted to indicate the departure of the individual user-based service provider. The sliding track feature of the graphic is dynamically refreshed to indicate the status of the individual service provider's travel to the selected on-site service location (as described below).

In some examples, the on-demand user-based service application that operates on the user's computing device can communicate with the on-demand user-based service system to receive real-time information about user-based service providers in the determined region of the user. The on-demand user-based service system can continually (periodically) receive data from the computing devices of the service providers (e.g., such as GPS data, and the barber) in order to determine the current location of the user-based user-based service providers, the speed and direction in which the user-based service provider is moving, whether a user-based service provider is currently providing a user-based service (e.g., is currently on-site), etc., and other user-based service provider information. The on-demand user-based service application can receive information about one or more user-based service providers in the vicinity of the user's current location or on-site location in order to provide real-time information to the user.

For example, based on the selected user-based service provider type and determined region, a graphic service provider indicator (if any) can be dynamically provided on the map to indicate to the user the current/real-time locations and movements of the user-based service providers having the selected service type. In one implementation, one or more graphic service provider indicators can move on the map corresponding to the real-time and real-life movements of the service providers' vehicles relative to the user's current location or on-site service location. The movements of the graphic service provider indicators can be determined using provider data (e.g., via provider information 192 transmitted by the user-based service system in FIG. 1) that includes GPS data of the providers' vehicles.

In one example, the barber service system can also use one or more databases of streets and roads for maps (e.g., including external databases maintained by third parties or other map sources) to determine how the graphic service provider indicator can be oriented and moved on a map that is presented to the user (e.g., as part of the booking/appointment status user interfaces 900b and 900c). The one or more databases can include geocoding information that make up individual streets and roads. By taking the GPS points or coordinates of the user-based service provider (from the service providers' devices) and drawing lines between the points, the GPS points and lines can be aligned with the geocoding information from the databases. In this manner, real-time user-based service provider movement and location can be correlated to maps of streets and roads so that the graphic service provider indicators can be displayed to the user. In addition, by map-fitting the GPS points with the known geolocations of streets, the barber service system can correct for inconsistencies and smooth out lines between GPS points so that the corresponding graphic service provider indicators can be accurately displayed on a map to the user on the user's computing device (e.g., on booking/appointment user interface 800c).

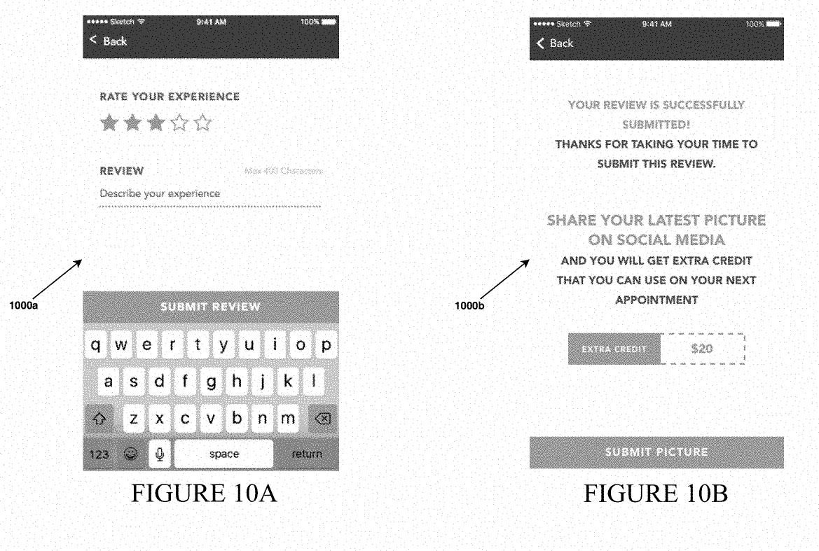

FIGS. 10A and 10B illustrate examples of a review appointment user interface and an image submission user interface that are displayed when the appointment is completed by the selected individual service provider. For example, the review appointment user interface 1000a of FIG. 10A can illustrate a user interface that is provided by a barber service application in response to the completion of the appointment by the selected individual service provider. The review appointment user interface 1000a can include rating selection feature that enables the user to select between one and five stars (via an input mechanism) depicting the level of satisfaction of their experience with the selected individual service provider as well as review text input feature that enables the user to input (via an input mechanism) a textual review of their experience with the selected individual service provider. Upon submission of the review within the review appointment user interface 1000a the on-demand user-based service application provides the image submission user interface 1000b. The image submission user interface 1000b of FIG. 10B can include a confirmation message that confirms to a user that their review has been submitted as well as a thank you message. The image submission user interface 1000b can also include an image/picture submission feature that enables the user to take and submit a photo/image/picture of the rendered service (e.g., a photo of the haircut, beard or moustache trim received) in exchange for a credit to the user's account, etc. The photo/image/picture can later be displayed within the past sessions user interface as well as shared to social media sites including Instagram™, Facebook™, Twitter™, etc.

The barber application can also provide specific information to the user using languages, symbols, and/or prices based on the user's location. For example, the different plurality of selection features can be identified in French, German, Spanish, etc., based on the country the user operates the barber application in (e.g., instead of “Haircut” or “Beard Trim”). A user can choose to have information provided by the transport application in a particular language (e.g., select a language for the application), such as when first installing the transport application or by selecting a language when first registering the user's device, etc. The user is also free to change languages upon his or her preference.

Hardware Examples

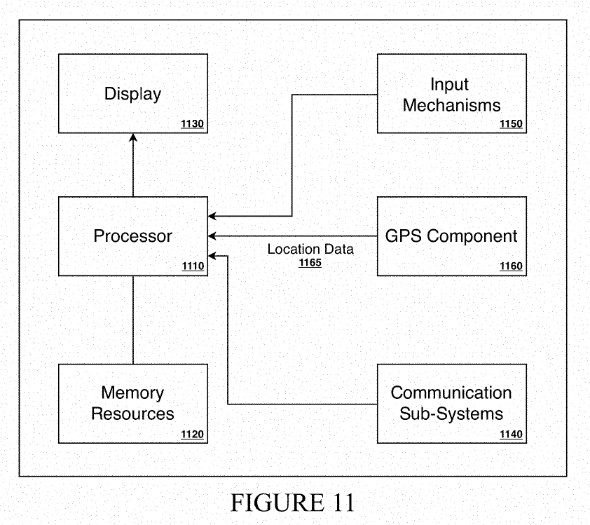

FIG. 11 is a block diagram that illustrates a mobile computing device upon which embodiments described herein may be implemented. In one embodiment, a computing device 1100 may correspond to a mobile computing device, such as a cellular device that is capable of telephony, messaging, and data services. Examples of such devices include smartphones, handsets or tablet devices for cellular carriers. Computing device 1100 includes a processor 1110, memory resources 1120, a display device 1130 (e.g., such as a touch-sensitive display device), one or more communication sub-systems 1140 (including wireless communication sub-systems), input mechanisms 1150 (e.g., an input mechanism can include or be part of the touch-sensitive display device), and one or more location detection mechanisms (e.g., GPS component) 1160. In one example, at least one of the communication sub-systems 1140 sends and receives cellular data over data channels and voice channels.

The processor 1110 is configured with software and/or other logic to perform one or more processes, steps and other functions described with implementations, such as described by FIGS. 1-9, and elsewhere in the application. Processor 1110 is configured, with instructions and data stored in the memory resources 1120, to operate an on-demand user-based service application as described in FIGS. 1-9. For example, instructions for operating the service application to display various user interfaces, such as described in FIGS. 3-10, can be stored in the memory resources 1120 of the computing device 1100. In one implementation, a user can operate the on-demand user-based service application so that location data 1165 can be received by the GPS component 1160. The location data 1165 can be used by the application to present user interface features that are made specific to the current location of the computing device 1100.

The location data 1165 can also be provided to the on-demand user-based service system using the communication sub-systems 1140. The communication sub-systems 1140 can enable the computing device 1100 to communicate with other servers and computing devices, for example, over a network (e.g., wirelessly or using a wireline). The location data 1165 can be communicated to the on-demand user-based service system so that when the user requests the on-demand user-based service, the system can arrange the service between the user and an available user-based service provider. The communication sub-systems 1140 can also receive provider information 1145 (such as location and/or movement information of drivers in real-time) from the on-demand user-based service system and transmit the provider information 1145 to the processor 1110 for displaying driver data on one or more user interfaces 1115.

The processor 1110 can cause user interface features to be presented on the display 1130 by executing instructions and/or applications that are stored in the memory resources 1120. In some examples, user interfaces 1115, such as user interfaces described with respect to FIGS. 3-10, can be provided by the processor 1110 based on user input and/or selections received from the user. In some implementations, the user can interact with the touch-sensitive display 1130 to make selections on the different user interface features 1115 so that region-specific information (that is based on the user selections) can be provided with the user interface features 1115. While FIG. 11 is illustrated for a mobile computing device, one or more embodiments may be implemented on other types of devices, including full-functional computers, such as laptops and desktops (e.g., PC).

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

1. A method for providing information about an on-demand user-based service on a computing device, the method being performed by one or more processors and comprising:
determining, via a global positioning system (GPS) component of the computing device, a current location or user-selected location of the computing device;
providing, on a display of the computing device, a plurality of selection features that are operative by a user to select at least one of a corresponding plurality of selection icons, states, boxes, or tiles, each of the plurality of selection icons, states, boxes, or tiles being associated with a corresponding user-based service option for providing a list of corresponding user-based service providers that are available for request by a user operating the computing device at the current location or user-selected location of the computing device, wherein the user-based service option that is associated with each of the plurality of selection icons, states, boxes, or tiles includes a user-based service type, a profession level of the user-based service provider, a number of users to receive a specific service, a date and time to render the user-based service, a user-based service location, and a specific service to be provided to the user by the user-based service provider which is different than a user-based service type, a profession level of the user-based service provider, a number of users to receive the specific service, a user-based service location, and a specific service to be provided to the user of the user-based service option associated with each of the other selection icons, states, boxes, or tiles of the plurality of selection icons, states, boxes, or tiles;
receiving, in connection with the plurality of selection features, a user input to select at least one of the corresponding plurality of selection icons, states, boxes, or tiles;
in response to receiving the user input, corresponding to the selected at least one of the corresponding plurality of selection icons, states, boxes, or tiles, providing, on the display, a user interface to provide the list of corresponding user-based service providers associated with the selected at least one of the corresponding plurality of selection icons, states, boxes, or tiles, the list of corresponding user-based service providers including a plurality of individual service provider selection panels, each including user-based service provider information that is specific to a user-based service provider associated with the corresponding individual service provider selection panel, the user-based service provider information including a profile/cover photo of the user-based service provider, a name of the user-based service provider, a favorites indicator, a rating score of the user-based service provider and a brief description of the user-based service provider;
wherein each of the user-based service providers of the list of corresponding user-based service providers provides on-demand service within the area having a predetermined distance from the current location or user-selected location and wherein each of the user-based service providers of the list of corresponding user-based service providers are capable of initiating travel, traveling to and rendering services at the current location or user-selected location;
wherein the plurality of selection features includes all of: a location selection feature including a drop down location selection feature which in turn includes location selection options, wherein the location selection options includes a location selection box which can allow a user to input the user-selected location by the user input, a map content, and a cancel selection box; and a date time selection feature including a drop down date time selection feature which in turn includes date time selection options, wherein the date time selection options include a calendar date selection feature which includes a plurality of date selection tiles, which can be side-scrolled in order amongst the plurality of date selection tiles by the user input to select one of the plurality of date selection tiles, said selected date selection tile being highlighted to indicate selection, and a time selection feature which includes a plurality of time selection tiles, which can be side-scrolled in order amongst the plurality of time selection tiles by the user input to select one of the plurality of time selection tiles, said selected time selection tile being highlighted to indicate selection;
wherein the list of corresponding user-based service providers that are available for request by a user operating the computing device at the current location or user-selected location of the computing device is dynamically updated according to selection of at least one of the plurality of selection features;
receiving a user input for a selection of one of the plurality of individual service provider selection panels;
in response to receiving the user input for the selection of the individual service provider selection panel, presenting a user-based service provider virtual shop user interface on the display;
the user-based service provider virtual shop user interface including the user-based service provider information, detailed user-based service provider information and a booking request feature, the detailed user-based service provider information including a photo gallery displaying the individual user-based service provider's work portfolio, a professional license number and license state of the individual user-based service provider, and specialties and specific cost information of services provided by the individual user-based service provider;
receiving a user input for a selection of the booking request feature;
in response to receiving the user input for the selection of the booking request feature, presenting a booking user interface on the display;
wherein the date time selection feature and a first set of selection option features are presented as part of the booking user interface, the first set of selection option features including a plurality of service option selection boxes, each one of the plurality of service option selection boxes individually selectable by the user input to select at least one of the plurality of service option selection boxes, wherein each one of the plurality of service option selection boxes corresponds to a specific service to be provided to the user by the individual user-based service provider;
wherein the booking user interface includes additional user-based service provider information and provides a continue booking request feature that can be selected by the user to request an on-demand user-based service using the user-based service option associated with the selected icons, states, boxes, or tiles
receiving a user input for a selection of the continue booking request feature; and
in response to receiving the user input for the selection of the continue booking request feature, presenting a confirmation user interface on the display;
wherein the confirmation user interface provides service-specific information about the user-based service option associated with the selected icons, states, boxes, or tiles with which the service request feature of the selection is provided, and address selection feature to enable the user to select one of at least three saved on-site user-based service locations or add a new address, a payment selection method to enable the user to select one of a plurality of saved payment methods or add a new payment method, and provides a complete booking service request feature, the service-specific information including the current location or user-selected location of the computing device, cost information, and account information of the user used to pay for the user-based on-demand service;
receiving a user input for a selection of the complete booking service request feature;
in response to receiving the user input for the selection of the complete booking service request feature, presenting a booking status user interface on the display;
wherein the booking status user interface includes a map that (i) indicates the current location of the computing device, (ii) a graphic feature that represents a current location of a selected user-based service provider of the user-based service option associated with the selected icons, states, boxes, or tiles, (iii) a status of the appointment which indicates a booking status of the appointment based on the selected user-based service provider, (iv) the profile/cover photo of the selected user-based service provider, and (v) a sliding track feature with stops depicting the status of the appointment and the location of the selected user-based service provider;
wherein the graphic feature moves on the map to reflect movement of the selected user-based service provider;
wherein the selected user-based service provider renders and completes the on-demand user-based service requested by the user at the selected on-site user-based service location;
wherein upon completion of the appointment by the selected user-based service provider a review appointment user interface and an image submission user interface are presented on the display, the review appointment user interface including a rating selection feature and a text input feature that enables the user to input a textual review of the user's experience with the selected user-based service provider, the photo submission user interface including an image submission feature that enables a user to take and submit a photo of the rendered on-demand user-based service requested by the user; and
wherein photo of the rendered on-demand user-based service requested by the user is displayed to the user within a past sessions user interface which is presented on the display in response to a user input for a selection of a corresponding display page selection icon.

2. The method of claim 1, further comprising:
receiving, in connection with the plurality of selection features, a second user input to select a second of the plurality of selection icons, states, boxes, or tiles; and
in response to receiving the second user input, dynamically updating the user interface to provide the list of corresponding user-based service providers associated with the first and second selected selection icons, states, boxes, or tiles, including the plurality of individual service provider selection panels, each including user-based service provider information that is specific to the user-based service provider associated with the corresponding individual service provider selection panel, the user-based service provider information including the profile/cover photo of the user-based service provider, the name of the user-based service provider; the favorites indicator, the rating score of the user-based service provider; and the brief description of the user-based service provider.

3-10. (canceled)

11. A non-transitory computer-readable medium storing instructions that, when executed by one or more processors of a computing system, cause the computing device to perform operations comprising:
determining, via a global positioning system (GPS) component of the computing device, a current location, or user-selected location of the computing device;
providing, on a display of the computing device, a plurality of selection features that are operative by a user to select at least one of a corresponding plurality of selection icons, states, boxes, or tiles, each of the plurality of selection icons, states, boxes, or tiles being associated with a corresponding user-based service option for providing a list of corresponding user-based service providers that are available for request by a user operating the computing device at the current location or user-selected location of the computing device, wherein the user-based service option that is associated with each of the plurality of selection icons, states, boxes, or tiles includes a user-based service type, a profession level of the user-based service provider, a number of users to receive a specific service, a date and time to render the user-based service, a user-based service location, and a specific service to be provided to the user by the user-based service provider which is different than a user-based service type, a profession level of the user-based service provider, a number of users to receive the specific service, a user-based service location, and a specific service to be provided to the user of the user-based service option associated with each of the other selection icons, states, boxes, or tiles of the plurality of selection icons, states, boxes, or tiles;
receiving, in connection with the plurality of selection features, a user input to select at least one of the corresponding plurality of selection icons, states, boxes, or tiles;
in response to receiving the user input, corresponding to the selected at least one of the corresponding plurality of selection icons, states, boxes, or tiles, providing, on the display, a user interface to provide the list of corresponding user-based service providers associated with the selected at least one of the corresponding plurality of selection icons, states, boxes, or tiles, the list of corresponding user-based service providers including a plurality of individual service provider selection panels, each including user-based service provider information that is specific to a user-based service provider associated with the corresponding individual service provider selection panel, the user-based service provider information including a profile/cover photo of the user-based service provider, a name of the user-based service provider, a favorites indicator, a rating score of the user-based service provider and a brief description of the user-based service provider;
wherein each of the user-based service providers of the list of corresponding user-based service providers provides on-demand service within the area having a predetermined distance from the current location or user-selected location and wherein each of the user-based service providers of the list of corresponding user-based service providers are capable of initiating travel, traveling to and rendering services at the current location or user-selected location;
wherein the plurality of selection features includes all of: a location selection feature including a drop down location selection feature which in turn includes location selection options, wherein the location selection options includes a location selection box which can allow a user to input the user-selected location by the user input, a map content, and a cancel selection box; and a date time selection feature including a drop down date time selection feature which in turn includes date time selection options, wherein the date time selection options include a calendar date selection feature which includes a plurality of date selection tiles, which can be side-scrolled in order amongst the plurality of date selection tiles by the user input to select one of the plurality of date selection tiles, said selected date selection tile being highlighted to indicate selection, and a time selection feature which includes a plurality of time selection tiles, which can be side-scrolled in order amongst the plurality of time selection tiles by the user input to select one of the plurality of time selection tiles, said selected time selection tile being highlighted to indicate selection;
wherein the list of corresponding user-based service providers that are available for request by a user operating the computing device at the current location or user-selected location of the computing device is dynamically updated according to selection of at least one of the plurality of selection features;
receiving a user input for a selection of one of the plurality of individual service provider selection panels;
in response to receiving the user input for the selection of the individual service provider selection panel, presenting a user-based service provider virtual shop user interface on the display;
the user-based service provider virtual shop user interface including the user-based service provider information, detailed user-based service provider information and a booking request feature, the detailed user-based service provider information including a photo gallery displaying the individual user-based service provider's work portfolio, a professional license number and license state of the individual user-based service provider, and specialties and specific cost information of services provided by the individual user-based service provider;
receiving a user input for a selection of the booking request feature;
in response to receiving the user input for the selection of the booking request feature, presenting a booking user interface on the display;
wherein the date time selection feature and a first set of selection option features are presented as part of the booking user interface, the first set of selection option features including a plurality of service option selection boxes, each one of the plurality of service option selection boxes individually selectable by the user input to select at least one of the plurality of service option selection boxes, wherein each one of the plurality of service option selection boxes corresponds to a specific service to be provided to the user by the individual user-based service provider;
wherein the booking user interface includes additional user-based service provider information and provides a continue booking request feature that can be selected by the user to request an on-demand user-based service using the user-based service option associated with the selected icons, states, boxes, or tiles
receiving a user input for a selection of the continue booking request feature; and
in response to receiving the user input for the selection of the continue booking request feature, presenting a confirmation user interface on the display;
wherein the confirmation user interface provides service-specific information about the user-based service option associated with the selected icons, states, boxes, or tiles with which the service request feature of the selection is provided, and address selection feature to enable the user to select one of at least three saved on-site user-based service locations or add a new address, a payment selection method to enable the user to select one of a plurality of saved payment methods or add a new payment method, and provides a complete booking service request feature, the service-specific information including the current location or user-selected location of the computing device, cost information, and account information of the user used to pay for the user-based on-demand service;
receiving a user input for a selection of the complete booking service request feature;
in response to receiving the user input for the selection of the complete booking service request feature, presenting a booking status user interface on the display;
wherein the booking status user interface includes a map that (i) indicates the current location of the computing device, (ii) a graphic feature that represents a current location of a selected user-based service provider of the user-based service option associated with the selected icons, states, boxes, or tiles, (iii) a status of the appointment which indicates a booking status of the appointment based on the selected user-based service provider, (iv) the profile/cover photo of the selected user-based service provider, and (v) a sliding track feature with stops depicting the status of the appointment and the location of the selected user-based service provider;
wherein the graphic feature moves on the map to reflect movement of the selected user-based service provider;
wherein the selected user-based service provider renders the on-demand user-based service requested by the user at the selected on-site user-based service location;
wherein upon completion of the appointment by the selected user-based service provider a review appointment user interface and an image submission user interface are presented on the display, the review appointment user interface including a rating selection feature and a text input feature that enables the user to input a textual review of the user's experience with the selected user-based service provider, the photo submission user interface including an image submission feature that enables a user to take and submit a photo of the rendered on-demand user-based service requested by the user; and
wherein photo of the rendered on-demand user-based service requested by the user is displayed to the user within a past sessions user interface which is presented on the display in response to a user input for a selection of a corresponding display page selection icon.

12. The non-transitory computer-readable medium of claim 11, further comprising:
receiving, in connection with the plurality of selection features, a second user input to select a second of the plurality of selection icons, states, boxes, or tiles; and
in response to receiving the second user input, dynamically updating the user interface to provide the list of corresponding user-based service providers associated with the first and second selected selection icons, states, boxes, or tiles, including the plurality of individual service provider selection panels, each including user-based service provider information that is specific to the user-based service provider associated with the corresponding individual service provider selection panel, the user-based service provider information including the profile/cover photo of the user-based service provider, the name of the user-based service provider; the favorites indicator, the rating score of the user-based service provider; and the brief description of the user-based service provider.

13-20. (canceled)
